(19) United States
(12) Patent Application Publication
(10) Pub. No.: US 2016/0077338 A1
(43) Pub. Date: Mar. 17, 2016

(54) Compact Projection Light Engine For A Diffractive Waveguide Display

(71) Applicants: Steven John Robbins, Redmond, WA (US); Ian Nguyen, Renton, WA (US)

(72) Inventors: Steven John Robbins, Redmond, WA (US); Ian Nguyen, Renton, WA (US)

(21) Appl. No.: 14/487,404

(22) Filed: Sep. 16, 2014

(51) Int. Cl. G02B 27/01; G02B 27/28; G02B 27/42; G09G 3/00; G02B 5/30; G02B 5/10; G02B 5/32; F21V 8/00; G02B 6/34

(52) U.S. Cl. CPC G02B 27/0172; G02B 6/0016; G02B 27/283; G02B 27/4205; G02B 6/34; G02B 5/3083; G02B 5/10; G02B 5/32; G09G 3/002; G02B 2027/0178; G02B 2027/0174

(57) ABSTRACT

The technology provides a waveguide display having a compact projection light engine and a diffractive waveguide. The diffractive waveguide includes input diffraction gratings with rolled k-vectors. The projection light engine provides collimating light to a projected exit pupil external to the diffractive waveguide. The projection light engine components may include a light (or illuminating) source, microdisplay, lenticular screen, doublet, polarizing beam splitter (PBS), clean-up polarizer, fold mirror, curved reflector and quarter waveplate. A method of manufacturing a diffractive waveguide includes providing input gratings with rolled k-vectors. Rays of light are diffracted by, and passed through, a master hologram to form input diffraction gratings of a copy substrate. A second copy substrate may likewise be formed with a different master hologram. Multiple copy substrates may be assembled to form a multi-layer diffractive waveguide (or multiple diffractive waveguides) having input diffraction gratings with increased diffraction efficiency and angular bandwidth.

### BACKGROUND

Waveguide displays support augmented reality (AR) and virtual reality (VR) experiences. A waveguide display may include a projection light engine that may provide a computer-generated image (CGI), or other information, in the waveguide display. In an AR experience, waveguide display may include optical see-through lens to allow a CGI to be superimposed on a real-world view of a user.

A waveguide display may be included in a head-mounted display (HMD) or head-up display (HUD). The waveguide display may be disposed by a support structure of a head-mounted display (HMD). An HMD may include a waveguide display in a helmet, visor, glasses, and goggles or attached by one or more straps. HMDs may be used in at least aviation, engineering, science, medicine, computer gaming, video, sports, training, simulations and other applications. HUDs may be used in at least military and commercial aviation, automobiles, military, ground and sea transports, computer gaming, and other applications.

### SUMMARY

The technology provides a waveguide display having a compact projection light engine and a diffractive waveguide with an input and output optical mechanism. The diffractive waveguide may utilize diffractive elements having input diffraction gratings with rolled k-vectors. The projection light engine components may include, but are not limited to, a light source or illuminating source (such as LEDs or Lasers), image source (microdisplay), lenticular screen (micro-lens array), doublet, polarizing beam splitter (PBS), another doublet, fold mirror, curved reflector and quarter waveplate. The technology facilitates the omission of a PBS element, which may reduce the volume, mass and number of components of the projection light engine. In an embodiment, a diffractive waveguide performs at least a function of another PBS in a projection light engine. In an embodiment a diffractive waveguide beam splits and polarizes image light from a projection light engine and outputs the image light to an external projected exit pupil.

Angular bandwidth that an input diffraction grating has to support may be less when using a projection light engine that provides a projected exit pupil as compared to an input diffraction grating that supports a whole field of view (FOV) of a waveguide display. In a projection light engine providing a projected exit pupil, the FOV of the waveguide display is distributed over a plurality of input diffractive gratings of the diffractive waveguide so that each input diffraction grating supports a fraction or potion of the FOV of the waveguide display.

The technology also provides a method of manufacturing a diffractive waveguide having input diffraction gratings with different associated k-vectors (or rolled k-vectors in an embodiment). The k-vector of a thick phase diffraction grating (such as a Bragg Grating) defines the angle at which the peak diffraction occurs for a given wavelength. During manufacture, rays of coherent light (such as a Laser) are diffracted by (first order diffraction mode), as well as passing straight through (zero order diffraction mode), a master hologram to form a standing wave interference pattern in the copy substrate. The interference pattern once recorded will be an input diffraction grating with a rolled k-vector. A second copy substrate may likewise be formed with a different master hologram associated with light having a different set of rolled k-vectors but with the same grating spacing. Multiple copy substrates may be assembled to form a multi-layer input diffraction grating stack (or multiple diffractive waveguides) having rolled k-vectors that are different for each layer while the grating period or spacing is the same. This multilayer stack may support a much broader angular bandwidth than can be supported by a single grating.

The technology provides one or more embodiments of a waveguide display. A projection light engine embodiment includes an apparatus comprising a microdisplay to provide an image light and a collimating lens to receive the image light and output the image light to a projected exit pupil. A PBS outputs image light to a microdisplay that reflects the image light from the PBS to the PBS that redirects the image light as redirected image light. A diffractive waveguide includes an input diffraction grating to receive the redirected image light from the PBS. The redirected image light from the PBS passes through the input diffraction grating un-deviated. A quarter waveplate also receives the redirected image light from the PBS and outputs the redirected image light. A curved reflector receives the redirected image light from the quarter waveplate. The curved reflector reflects and collimates the redirected image light back to the quarter waveplate that outputs the redirected image light to the input diffraction grating. The redirected image light from the quarter waveplate is diffracted by the input diffraction grating.

In one such embodiment, a PBS outputs polarized light of one polarization state to the microdisplay where it is reflected back towards the PBS. Light that is within the region of an active pixel of the microdisplay is rotated in the polarization state through 90 degrees and this time reflected by the PBS.

In one embodiment, polarized light from the microdisplay falls incident on the input diffraction grating of the diffractive waveguide and passes straight through the input diffraction grating un-deviated (allowed to pass without diffraction). A curved reflector receives the image light as well as reflects and collimates the image light. A quarter waveplate outputs the image light to and from the curved reflector and rotates the polarization through 90 degrees and outputs the image light to a projected exit pupil. The image light from the microdisplay falls incident on the input diffraction grating for a second time and is then diffracted into the diffractive waveguide. The diffraction input grating in this embodiment may be substantially sensitive to polarized light in one state and insensitive to light polarized in the orthogonal state.

The technology provides one or more embodiments of a holographic recording method comprising directing a first ray of light along a first optical path to a master hologram. The master hologram diffracts 50% of the first ray of light to a second optical path through a holographic recording medium (or copy substrate). A second ray of light is directed along a third optical path to the master hologram. The second ray of light transmits 50% un-deviated (or allowed to pass without diffraction) through the master hologram. The second ray of light intersect the first ray of light at a first point in the holographic recording medium. The resultant interference between the first beam and the second beam at the first point is recorded in the holographic recording medium to become the input diffraction grating of the waveguide display.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram depicting example components of an embodiment of a near-eye display (NED) device system.

FIG. 2A is a block diagram of example hardware components in a control circuitry embodiment of a NED device.

FIG. 2B is a top view of a near-eye display embodiment being coupled with a projection light engine having an external exit pupil.

FIG. 3A is a block diagram of a compact projection light engine embodiment.

FIG. 3B is a block diagram illustrating a top view of layers of a waveguide embodiment illustrated in FIG. 3A.

FIG. 3C is a block diagram of another compact light engine embodiment and waveguide.

FIGS. 4A-B illustrates another compact light engine embodiment.

FIGS. 5A-C illustrate embodiments of providing a master hologram used to manufacture a copy substrate having input diffraction gratings with rolled k-vectors.

FIGS. 6A-B illustrates a method embodiment of manufacturing a copy substrate that may be used in a diffractive waveguide having input diffraction gratings with rolled k-vectors.

FIG. 7 illustrates an embodiment of housing a projection light engine having an external exit pupil to be coupled in a near-eye display of a NED device.

FIG. 8 is a block diagram embodiment of a system from a software perspective for displaying image data by a NED device.

FIGS. 9A-B are flowcharts of a method embodiment for manufacturing a diffractive waveguide having input diffraction gratings with rolled k-vectors.

FIG. 10 is a block diagram embodiment of a computing system that may be used to implement a network accessible computing system, a companion processing module or control circuitry of a NED device.

### DETAILED DESCRIPTION

The technology provides a waveguide display having a compact projection light engine and a diffractive waveguide. The diffractive waveguide includes input diffraction gratings with rolled k-vectors. The projection light engine may include, but not limited to, an image source (such as a microdisplay), illuminating sources (such as LEDs or Lasers), doublet, polarizing beam splitter (PBS), curved reflector and quarter waveplate. At least some of the optical components may be coplanar and disposed on a single printed circuit board. The projection light engine may have components that are not immersed in high index glass and omit an additional PBS element, which may reduce the volume, mass and number of components of the projection light engine. The waveguide display may be disposed by a support structure of a head-mounted display (HMD). In an embodiment, a diffractive waveguide performs at least a function of another PBS in a projection light engine. In an embodiment a diffractive waveguide beam splits and polarizes image light from a projection light engine and outputs the image light to an external projected exit pupil.

The technology also provides a method of manufacturing a diffractive waveguide having rolled k-vector input diffraction gratings. Rays of light are diffracted by, as well as passing through, a master hologram to form an interference fringe pattern within a holographic recording medium (or copy substrate) where the planes of positive interference vary in angle along the medium. The fringes are recorded in the medium and form a Bragg grating where the k-vector of each of the input diffraction gratings varies along the medium. The behavior of the k-vector variation is described as a rolling k-vector. A second copy substrate may likewise be formed with a different master hologram associated with a light having a different set of wavelengths. Multiple copy substrates may be assembled to form a multi-layer diffractive waveguide (or multiple waveguides) having input diffraction gratings with increased angular bandwidth.

Waveguide displays may have an advantage over typical projection displays since the internal mechanisms expand the exit pupil so that a relatively large exit pupil can be generated from a small entrance pupil. The light forming the entrance pupil is generated by a projection light engine that collimates light from a microdisplay, such as a liquid crystal on silicon (LCoS) display. The internal mechanisms replicate the entrance pupil, overlapping these replicated entrance pupils so that the display light has acceptable luminance uniformity. For example, a projection light engine's exit pupil could have a 4 mm exit pupil but the waveguide display may have an exit pupil of 20 mm at the eye plane (or projected exit pupil). Internal mechanism can include two input diffraction gratings that can expand the exit pupil in one direction and then expand the exit pupil in the orthogonal direction.

Diffractive technologies, such as diffractive waveguides, may include surface relief gratings and thick phase Bragg gratings. These gratings may have limited angular bandwidth which may reduce the efficiency of a waveguide display system at the edge of FOV. This reduced efficiency may reduce the see-through luminance contrast of a near-eye display. For example, virtual holograms projected on the outside would, by a waveguide display, may appear to fade at the edge of the FOV and may appear less real.

A typical input diffraction grating has a limited angular bandwidth, especially for high efficiency input diffraction gratings. For example, a typical thick phase grating may have a diffraction efficiency of greater than 80%; yet, the beam of light should be received within a range of around 5 degrees about a target angle for a particular input diffraction grating. For example, particular photopolymer holographic material may have such diffraction characteristics. In other words, in order for 80% of the information associated with the beam of light to reach a user's eye, by way of the diffractive waveguide, the beam of light should be within about 5 degree range about a target incident angle of a particular input diffraction grating. This FOV limitation may be overcome by the technology described herein.

In method embodiments described herein, a method of manufacturing input diffraction gratings of a diffractive waveguide is provided that may increase an angular bandwidth of at least some of the input diffraction gratings. Input grating geometry is designed so that the angular bandwidth shifts in space from one input diffraction grating to another input diffraction grating. The input diffraction grating geometry may be used in diffractive waveguides having surface relief grating or thick phase gratings. In an embodiment, a k-vector associated with each input diffraction grating is varied and/or rolls with each input diffraction grating from one end of input diffraction grating to the other end of the input diffraction grating. In other words, angular bandwidth is spatially tuned by rolling the k-vector as the angle of incident of an incident light beam changes across the grating.

In an embodiment, a k-vector is defined as a vector perpendicular to the Bragg planes in a Bragg grating. In an embodiment, a Bragg plane is the plane of constructive interference in a Bragg grating. In an embodiment, a k-vector is defined mathematically in a paper entitled: “Coupled Wave Theory of Thick Hologram Grating,” Kogelnik, H., The Bell System Technical Journal, May 23, 1969 (Kogelnik Paper). In an embodiment, a k-vector is defined as a “K-grating vector (perpendicular to the fringe planes)” in the Kogelnik Paper.

The rolled k-vector input diffraction gratings of a diffractive waveguide and a projection light engine as described herein may provide high efficiency and uniform luminance across the FOV of the waveguide display. In an alternate embodiment, multiplexed input diffraction gratings may be used.

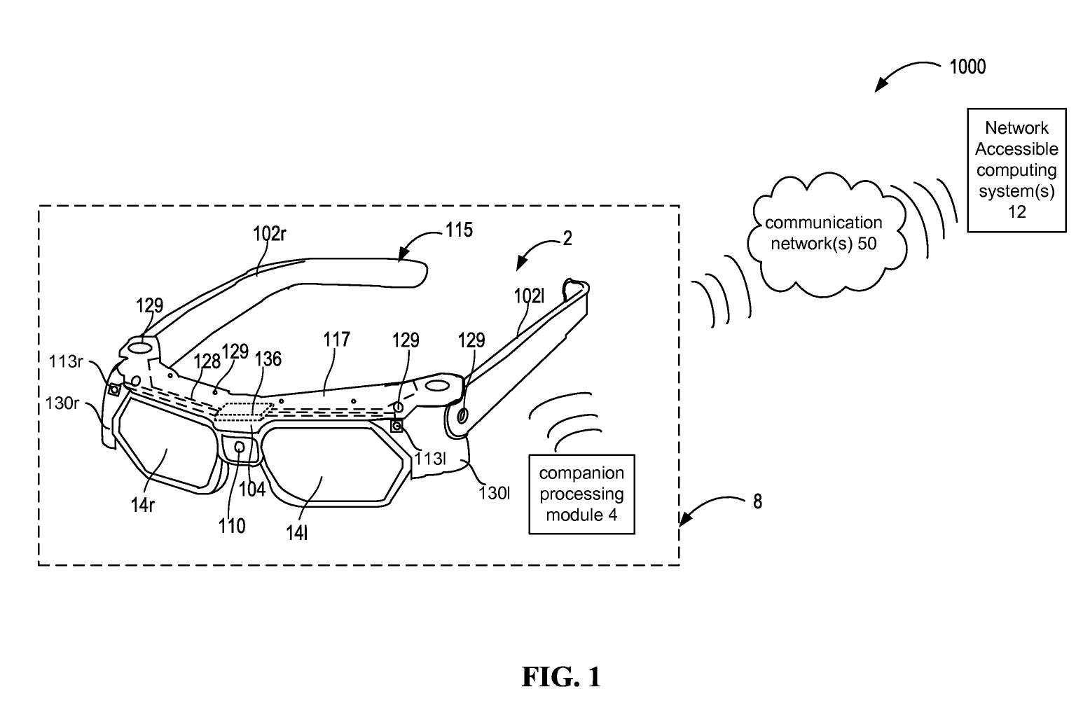

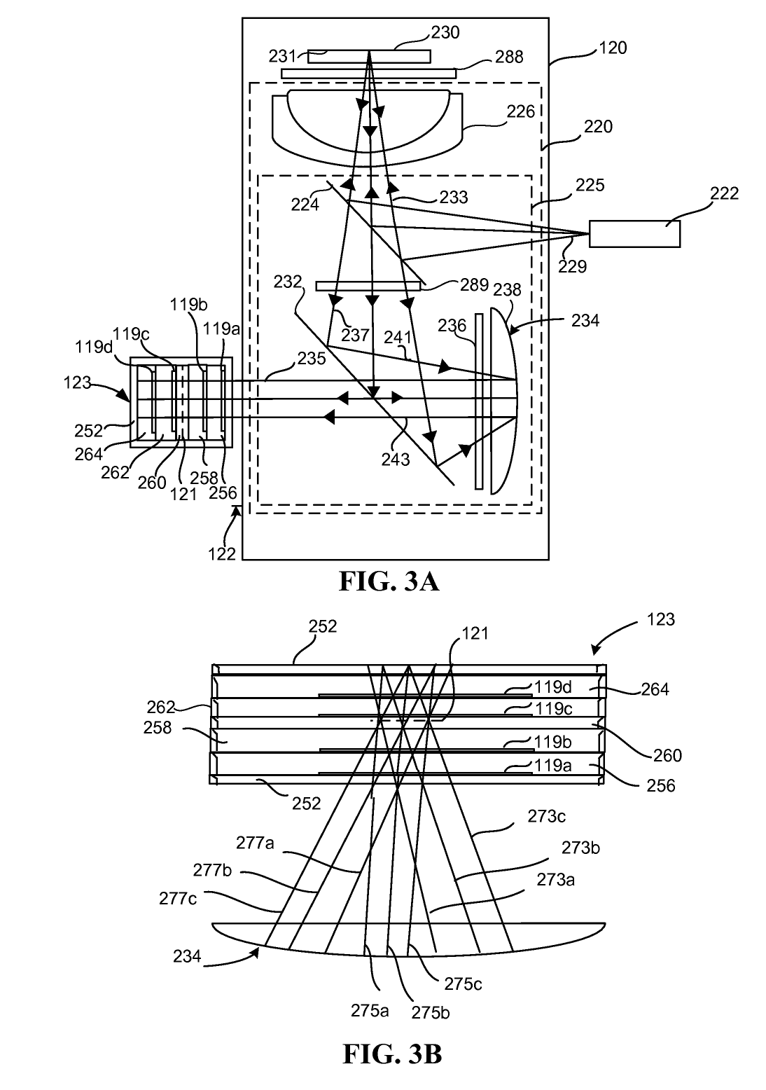

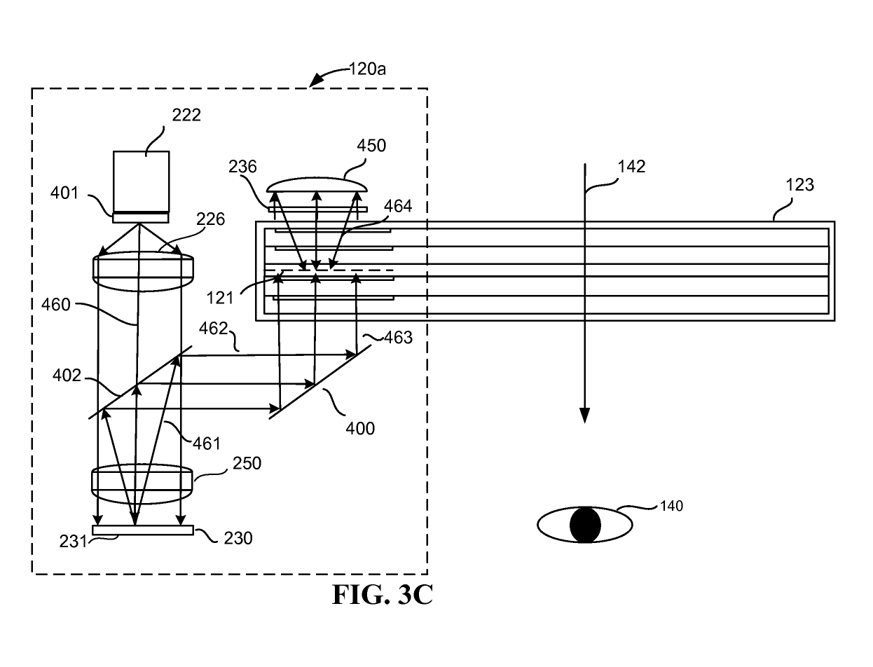

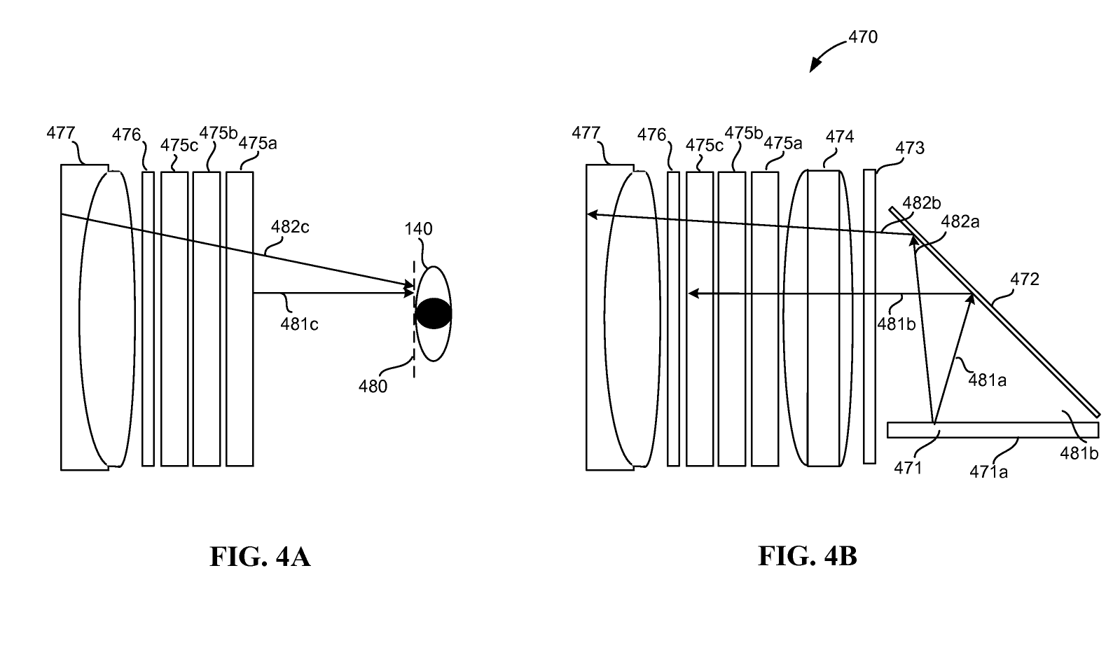

FIG. 1 is a block diagram depicting example components of a waveguide display implemented in a Near Eye Display (NED) system 8 including a compact projection light engine and diffractive waveguide having rolled k-vector input diffraction gratings. In the illustrated embodiment, a NED device system 8 includes a near-eye display (NED) device in a head-mounted display (HMD) device 2 and companion processing module 4. HMD 2 is communicatively coupled to companion processing module 4. Wireless communication is illustrated in this example, but communication via a wire between companion processing module 4 and HMD 2 may also be implemented. In an embodiment, HMD 2 includes a NED device having a projection light engine 120 (shown in FIGS. 3A, 3C and 4) and near-eye display 14 having a diffractive waveguide as described in detail herein.

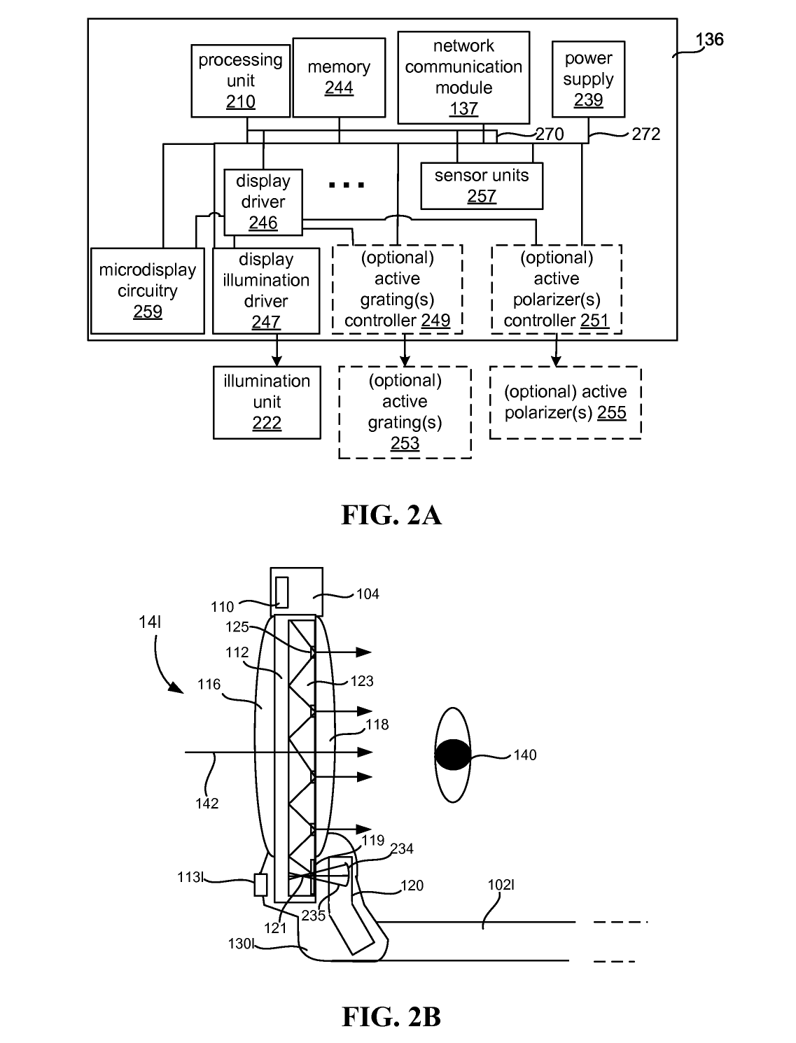

In this embodiment, HMD 2 is in the shape of eyeglasses having a frame 115, with each display optical system 14l and 14r positioned at the front of the HMD 2 to be seen through by each eye when worn by a user. Each display optical system 14l and 14r is also referred to as a display or near-eye display 14, and the two display optical systems 14l and 14r together may also be referred to as a display or near-eye display 14. In this embodiment, each display optical system 14l and 14r uses a projection display in which image data (or image light) is projected into a user's eye to generate a display of the image data so that the image data appears to the user at a location in a three dimensional FOV in front of the user. For example, a user may be playing a shoot down enemy helicopter game in an optical see-through mode in his living room. An image of a helicopter appears to the user to be flying over a chair in his living room, not between optional lenses 116 and 118, shown in FIG. 2B, as a user cannot focus on image data that close to the human eye.

In this embodiment, frame 115 provides a convenient eyeglass frame holding elements of the HMD 2 in place as well as a conduit for electrical connections. In an embodiment, frame 115 provides a NED device support structure for a projection light engine 120 and a near-eye display 14 as described herein. Some other examples of NED device support structures are a helmet, visor frame, goggles support or one or more straps. The frame 115 includes a nose bridge 104, a front top cover section 117, a respective projection light engine housing 130 for each of a left side housing (130l) and a right side housing (130r) of HMD 2 as well as left and right temples or side arms 102l and 102r which are designed to rest on each of a user's ears. In this embodiment, nose bridge 104 includes a microphone 110 for recording sounds and transmitting audio data to control circuitry 136. On the exterior of the side housing 130l and 130r are respective outward capture devices 113l and 113r (such as cameras) which capture image data of the real environment in front of the user for mapping what is in a FOV of a near-eye display (NED) device.

In this embodiment, dashed lines 128 are illustrative examples of some electrical connection paths which connect to control circuitry 136, also illustrated in dashed lines. One dashed electrical connection line is labeled 128 to avoid overcrowding the drawing. The electrical connections and control circuitry 136 are in dashed lines to indicate they are under the front top cover section 117 in this example. There may also be other electrical connections (not shown) including extensions of a power bus in the side arms for other components, some examples of which are sensor units including additional cameras, audio output devices like earphones or units, and perhaps an additional processor and memory. Some examples of connectors 129 as screws are illustrated which may be used for connecting the various parts of the frame together.

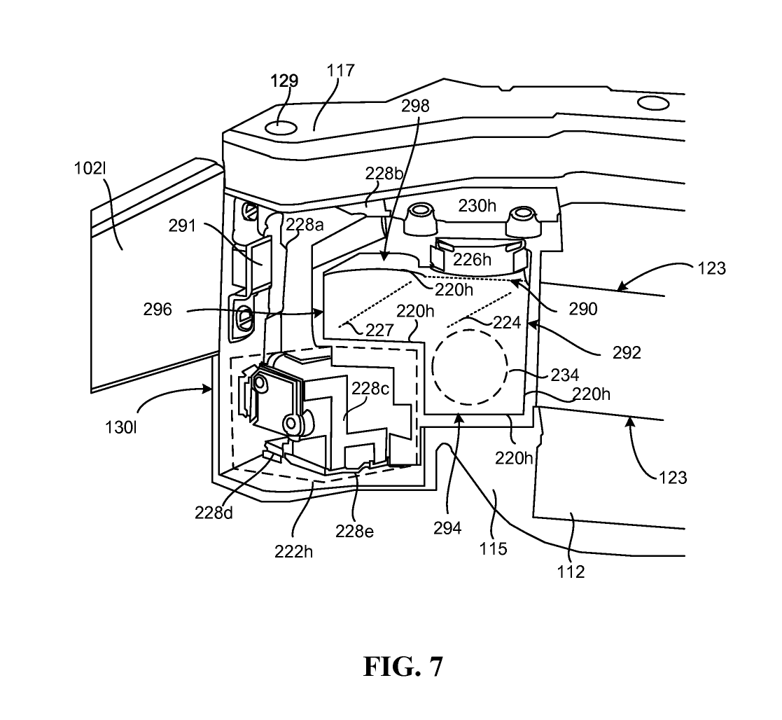

The companion processing module 4 may take various embodiments. In some embodiments, companion processing module 4 is in a portable form which may be worn on the user's body, e.g. a wrist, or be a separate portable computing system like a mobile device (e.g. smartphone, tablet, laptop). The companion processing module 4 may communicate using a wire or wirelessly (e.g., WiFi, Bluetooth, infrared, an infrared personal area network, RFID transmission, wireless Universal Serial Bus (WUSB), cellular, 3G, 4G or other wireless communication means) over one or more communication network(s) 50 to one or more network accessible computing system(s) 12, whether located nearby or at a remote location. In other embodiments, the functionality of the companion processing module 4 may be integrated in software and hardware components of HMD 2. Some examples of hardware components of the companion processing module 4 and network accessible computing system(s) 12 are shown in FIG. 7.

One or more network accessible computing system(s) 12 may be leveraged for processing power and remote data access. The complexity and number of components may vary considerably for different embodiments of the network accessible computing system(s) 12 and the companion processing module 4. In an embodiment illustrated in FIG. 1, a NED device system 1000 may include near-eye display (NED) device system 8 (with or without companion processing module 4), communication(s) network 50 and network accessible computing system(s) 12. In an embodiment, network accessible computing system(s) 12 may be located remotely or in a Cloud operating environment.

Image data is identified for display based on an application (e.g. a game or messaging application) executing on one or more processors in control circuitry 136, companion processing module 4 and/or network accessible computing system(s) 12 (or a combination thereof) to provide image data to near-eye display 14.

FIG. 2A is a block diagram of example hardware components including a computing system within control circuitry of a NED device. Control circuitry 136 provides various electronics that support the other components of HMD 2. In this example, the control circuitry 136 for a HMD 2 comprises a processing unit 210, a memory 244 accessible to the processing unit 210 for storing processor readable instructions and data. A network communication module 137 is communicatively coupled to the processing unit 210 which can act as a network interface for connecting HMD 2 to another computing system such as the companion processing module 4, a computing system of another NED device or one which is remotely accessible over the Internet. A power supply 239 provides power for the components of the control circuitry 136 and the other components of the HMD 2 like the capture devices 113, the microphone 110, other sensor units, and for power drawing components for displaying image data on near-eye display 14 such as light sources and electronic circuitry associated with an image source like a microdisplay in a projection light engine.

The processing unit 210 may comprise one or more processors (or cores) such as a central processing unit (CPU) or core and a graphics processing unit (GPU) or core. In embodiments without a separate companion processing module 4, processing unit 210 may contain at least one GPU. Memory 244 is representative of the various types of memory which may be used by the system such as random access memory (RAM) for application use during execution, buffers for sensor data including captured image data and display data, read only memory (ROM) or Flash memory for instructions and system data, and other types of nonvolatile memory for storing applications and user profile data, for example. FIG. 2A illustrates an electrical connection of a data bus 270 that connects sensor units 257, display driver 246, processing unit 210, memory 244, and network communication module 137. Data bus 270 also derives power from power supply 239 through a power bus 272 to which all the illustrated elements of the control circuitry are connected for drawing power.

Control circuitry 136 further comprises a display driver 246 for selecting digital control data (e.g. control bits) to represent image data that may be decoded by microdisplay circuitry 259 and different active component drivers of a projection light engine (e.g. 120 in FIG. 2B). A microdisplay, such as microdisplay 230 shown in FIG. 3C, may be an active transmissive, emissive or reflective device. For example, a microdisplay may be a liquid crystal on silicon (LCoS) device requiring power or a micromechanical machine (MEMs) based device requiring power to move individual mirrors. An example of an active component driver is a display illumination driver 247 which converts digital control data to analog signals for driving an illumination unit 222 which includes one or more light sources, such as one or more lasers or light emitting diodes (LEDs). In some embodiments, a display unit may include one or more active gratings 253, such as for a waveguide, for coupling the image light at the exit pupil from the projection light engine. An optional active grating(s) controller 249 converts digital control data into signals for changing the properties of one or more optional active grating(s) 253. Similarly, one or more polarizers of a projection light engine may be active polarizer(s) 255 which may be driven by an optional active polarizer(s) controller 251. The control circuitry 136 may include other control units not illustrated here but related to other functions of a HMD 2 such as providing audio output, identifying head orientation and location information.

FIG. 2B is a top view of an embodiment of a near-eye display 14l being coupled with a projection light engine 120 having an external exit pupil 121. In order to show the components of the display optical system 14, in this case 14l for the left eye, a portion of the top frame section 117 covering the near-eye display 14l and the projection light engine 120 is not depicted. Arrow 142 represents an optical axis of the near-eye display 14l.

In this embodiment, the near-eye displays 14l and 14r are optical see-through displays. In other embodiments, they can be video-see displays. Each display includes a display unit 112 illustrated between two optional see-through lenses 116 and 118 and including a waveguide 123. The optional lenses 116 and 118 are protective coverings for the display unit. One or both of them may also be used to implement a user's eyeglass prescription. In this example, eye space 140 approximates a location of a user's eye when HMD 2 is worn. The waveguide directs image data in the form of image light from a projection light engine 120 towards a user's eye space 140 while also allowing light from the real world to pass through towards a user's eye space, thereby allowing a user to have an actual direct view of the space in front of HMD 2 in addition to seeing an image of a virtual feature from the projection light engine 120.

In this top view, the projection light engine 120 includes a birdbath optical element 234 illustrated as a curved surface. The curved surface provides optical power to the beams 235 of image light (also described as image light 235) it reflects, thus collimating them as well. Only one beam is labeled to prevent overcrowding the drawing. In some embodiments, the radius of curvature of the birdbath optical element is at least −38 millimeters (mm) The beams are collimated but come from different angles as they reflect from different points of the curved surface. Thus, the beams will cross and form the exit pupil 121 at the smallest cross-section of themselves.

In some embodiments, a waveguide 123 may be a diffractive waveguide. Additionally, in some examples, a waveguide 123 is a surface relief grating (SRG) waveguide. In an embodiment as described herein, waveguide 123 includes rolled k-vector input diffraction gratings. An input diffraction grating 119 couples an image light from a projection light engine 120. Additionally, a waveguide has a number of exit gratings 125 for an image light to exit the waveguide in the direction of a user's eye space 140. One exit grating 125 is labeled to avoid overcrowding the drawing. In this example, an outermost input diffraction grating 119 is wide enough and positioned to capture light exiting a projection light engine 120 before the light exiting the projection light engine has reached its exit pupil 121. The optically coupled image light forms its exit pupil in this example at a central portion of the waveguide. See FIG. 3B for a more detailed example. FIGS. 3A-B described herein provide an example of a waveguide coupling the image light at an exit pupil with an input diffraction grating positioned at the exit pupil.

The exit pupil 121 includes the light for the complete image being displayed, thus coupling light representing an image at the exit pupil 121 captures the entire image at once, and is thus very efficient and provides the user a view of the complete image in a near-eye display 14. An input diffraction grating 119 is able to couple an image light of an exit pupil 121 because the exit pupil 121 is external to the projection light engine 120. In an embodiment, an exit pupil 121 is 0.5 mm outside a projection light engine 120 or housing of the projection light engine. In other embodiments, the exit pupil 121 is projected 5 mm outside the projection light engine 120 or housing of the projection light engine.

In the illustrated embodiment of FIG. 2B, the projection light engine 120 in a left side housing 130l includes an image source, for example a microdisplay, which produces the image light and a projection optical system which folds an optical path of the image light to form an exit pupil 121 external to the projection light engine 120. The shape of the projection light engine 120 is an illustrative example adapting to the shape of the example of left side housing 130l which conforms around a corner of the frame 115 in FIG. 1 reducing bulkiness. The shape may be varied to accommodate different arrangements of the projection light engine 120, for example due to different image source technologies implemented. For example, FIG. 4 as described herein illustrates a different orientation. In an embodiment, a projection light engine 120 may include at least portions of components that are coplanar and may be disposed on a substrate, such as a single printed circuit board (PCB), as illustrated in FIG. 4 and described herein.

There are different image generation technologies that can be used to implement an image source, such as microdisplay 230 described herein. For example, a microdisplay can be implemented using a transmissive projection technology. In one example of such technology, a light source is modulated by optically active material; the material is usually implemented using a transmissive LCD type microdisplay with powerful backlights and high optical energy densities. Other microdisplays use a reflective technology for which light from an illumination unit is reflected and modulated by an optically active material. The illumination maybe a white source or RGB source, depending on the technology. Digital light processing (DLP), digital micromirror device (DMD) and LCOS are all examples of reflective technologies which may be used by the display. Additionally, a microdisplay can be self-emitting, such as a color-emitting organic light emitting diode (OLED) microdisplay or an array of LEDs. LED arrays may be created conventionally on GaN substrates with a phosphor layer for spectral conversion or other color conversion method. Self-emissive displays may be relayed and magnified for a viewer.

FIG. 2B shows half of a HMD 2. For the illustrated embodiment, a full HMD 2 may include another display optical system 14 with another set of optional see-through lenses 116 and 118, another waveguide 123, as well as another projection light engine 120, and another of outward facing capture devices 113. In some embodiments, there may be a continuous display viewed by both eyes, rather than a display optical system for each eye. In some embodiments, a single projection light engine 120 may be optically coupled to a continuous display viewed by both eyes or be optically coupled to separate displays for the eyes. Additional details of a head mounted personal A/V apparatus are illustrated in U.S. patent application Ser. No. 12/905,952 entitled Fusing Virtual Content Into Real Content, Filed Oct. 15, 2010.

FIG. 3A is a block diagram of an embodiment of a projection light engine 120 using a birdbath optical element 234 and quarter waveplate 236. In an embodiment, birdbath optical element 234 and quarter waveplate 236 are immersed in a high index glass region 225 which helps in folding the optical path to provide an exit pupil 121 external to the projection light engine. In this embodiment, high index glass having an index of refraction between 1.7 and 1.8 is used. Some examples of high index glass are flint glass and glass having an index of refraction of at least 1.65. This side view illustrates some exemplary basic elements associated with a birdbath projection optical system. Additional optical elements may be present in various embodiments, such as aspheric optical elements and/or polarizers.

In this embodiment, the projection light engine 120 includes an image source and a projection optical system 220. In an embodiment, an image source is a microdisplay 230, such as a reflective LCoS microdisplay, with an accompanying compensator optical element 288 and clean-up polarizer optical element 289. In this embodiment, the microdisplay 230 has a surface 231 which reflects light from an illumination unit 222 for representing the image data to be displayed. The surface 231 polarizes light it reflects; however there may be polarization errors. Clean-up polarizer optical element 289 corrects for polarizer errors of the LCoS surface. A compensator optical element 288 is an optical element whose compensation parameters may be determined during manufacture of the LCoS microdisplay to compensate for errors measured for the LCoS surface during manufacture.

The projection optical system 220 in this embodiment includes a doublet 226 outside a high index glass region 225 and a number of optical components within the high index glass region 225. The doublet 226 corrects for chromatic aberration and also provides some collimation to the image light reflecting off the surface 231. In an embodiment, doublet 226 may be a spherical doublet. Those optical elements comprise an illumination optical directing element 224, another optical directing element 232 (such as polarizer and beam splitter (PBS)), a quarter waveplate 236 and a birdbath optical element 234 with a curved reflective surface 238. In other embodiments, like embodiments using a transmissive or emissive image source including its own illumination unit 222, besides omitting the doublet, optical directing element 224 may also be omitted from the projection optical system 220.

An optical path of light through these elements is discussed next. Different portions of the illumination light and image light are labeled with different numbers to facilitate discussing the progress of the light. To avoid overcrowding the drawing, only one representation ray of the beam is labeled at each stage of the path. Light 229 generated by the illumination unit 222 is directed to the polarizing illumination optical directing element 224 which directs the light 233 in the direction of the surface 231. While traveling to the surface 231, the illumination light passes through the doublet 226 and compensator optical element 288.

Some examples of illumination sources which the illumination unit 222 may include are light emitting diodes (LEDs) and lasers. In some embodiments, there may be separate red, green and blue (RGB) illumination sources, and in other embodiments, there may be a white light source and filters used to represent different colors. In this embodiment, a color sequential LED device is used in the illumination unit 222. The color sequential device includes red, blue and green LEDs which are turned on in a sequential manner in timing with the LCoS microdisplay for making a full color image. In other examples, lasers rather than LEDs may be used. Individual display elements on the surface 231 are controlled by the microdisplay circuitry 259 to reflect or absorb the red, green and blue light to represent the color or shade of gray for grayscale indicated by the display driver 246 for the image data.

The image light 237 polarized and reflected from the surface 231 passes through optical compensator 288. Image light 237 is partially focused by the doublet 226. Image light 237 enters the high index glass region 225, passes through the illumination optical directing element 224, clean-up polarizer optical element 289 and intercepts optical directing element 232 which directs the again polarized reflected light 241 through the quarter waveplate 236, which again passively alters the polarization state of the reflected light, to the curved reflective surface 238 of the birdbath optical element 234 which collimates and reflects the image light back through the quarter waveplate 236 for another polarization state alteration. The quarter waveplate provides circular polarization while the optical directing elements 224, 232 generally act as linear polarizers. The birdbath reflected, and twice quarter turned, image light 243 passes through optical directing element 232. The image light 235 then exits projection light engine 120 for optical coupling into waveguide 123.

In embodiments, optical directing element 232 is a type of beam splitter selected from a group consisting of cube, plate and wire-grid polarizer. For example, optical directing element 232 may be a cube beam splitter, plate beam splitter or wire-grid polarizing beam splitter.

In an embodiment, birdbath optical element 234 is a spherical or aspherical birdbath reflective mirror.

Image light 235 may have been polarized for more efficient coupling into one or more input diffraction gratings, such as the one or more input diffraction gratings of a diffractive waveguide. In some examples, a waveguide may have multiple layers, and the polarization of the incoming image light can be used for filtering the incoming light to different layers of the waveguide. Each layer has its own input diffraction grating and exit grating. An input diffraction grating for a layer couples light of a certain polarization into its layer. Light of other polarizations is passed through the input diffraction grating and the layer itself so that an input diffraction grating of the next layer either couples or passes the received light based on its polarization. In some implementations, different wavelength bands or sets of wavelengths of light, such as for different colors, may be directed to different waveguide layers for enhancing brightness of the image. Light in the different wavelength bands may be polarized for coupling into a respective layer for each wavelength band. See for example, U.S. patent application Ser. No. 13/601,727 with a filing date of Aug. 31, 2012 entitled “NED Polarization System for Wavelength Pass-Through” to Nguyen et al.

The arrangement of one or more polarizing optical elements within the high index glass region 225 may be based on a number of factors including a number of layers in the waveguide 123, the types of gratings (e.g. surface relief gratings) and a predetermined criteria for distributing the image light among the layers. The image light 235 are collimated when reflected from the birdbath curved reflective surface 238, but each portion is reflecting from a different angle due to the curved surface. (See FIG. 3B for an example of a top view of multiple beams having their smallest cross-section at the exit pupil.) In this embodiment, an input diffraction grating 119 of a waveguide 123 couples the reflected beam at about an exit pupil 121. In this embodiment, waveguide 123 may be a single layer waveguide. In other embodiments illustrated in FIGS. 3A-C, a multi-layer waveguide may be implemented in the near-eye display 14.

Immersing optical elements in high index glass extends the optical path length enough to allow for fold mechanisms to be employed to enable compact packaging of the light engine and to provide an optical path for the illumination source 222. In other embodiments described herein, high index glass is not used.

The bird-bath configuration geometrically allows the exit pupil of the light engine to extend outside the light engine and inside the waveguide assembly. Coupling light at the exit pupil within the waveguide decreases the size of the input diffraction grating.

A cross-sectional side view of the waveguide 123 is shown in FIG. 3A (and FIG. 3B). The waveguide 123 extends into the page and into the near-eye display 14 approximately parallel to the eye area 140 and extends a much smaller amount out of the page. In this embodiment, the waveguide 123 is multi-layered with four exemplary layers, 256, 258, 262 and 264, and a center waveplate 260, in this embodiment. Line 122 indicates a distance between the projection light engine 120 (or projection light engine housing) and the waveguide 123. FIG. 3A is not drawn to scale, but an example of such a distance between the projection light engine 120 and the waveguide 123 is about 0.5 mm. In center waveplate 260 is a target location for an exit pupil to be projected. In this embodiment, again not drawn to scale, the exit pupil is projected about 5 mm from the outside of the projection light engine 120 to the center waveplate 260 of the waveguide. Additionally, in this example, the waveguide 123 has an index of refraction about 1.7 which is in the range of high index glass.

In this embodiment, an outer protective covering 252 of see-through glass surrounds waveguide 123 through which the image light 235 passes. The waveguide 123 is positioned within housing 130 for optical coupling of the image light of the exit pupil 121 in the center waveplate 260. Each of the four layers has its own input diffraction grating. An example of an input diffraction grating is a surface relief grating manufactured as part of the surface of each layer in the waveguide 123. Layer 256 first receives the image light 235 which has exited the projection light engine 120 and couples that light through its optical input diffraction grating 119a. Similarly, layer 258 couples the image light 235 through its optical input diffraction grating 119b. The center waveplate layer 260 couples and changes the polarization state of the image light 235 it has received including the exit pupil. Layer 262 via optical input diffraction grating 119c couples the image light 235 as its cross section expands, and layer 264 couples the image light 235 with its optical grating 119d as the cross section of the image light 235 continues to expand.

FIG. 3B is a block diagram illustrating a top view of the four layers and the center waveplate of the waveguide 123 embodiment in FIG. 3A illustrated with a birdbath optical element 234 for reference (not drawn to scale). The intervening elements are not shown to more easily show the beams 273, 275 and 277. Each set of three rays (e.g. 273a, 273b, 273c) represents a beam (e.g. 273). Each beam may include light representing a plurality of colors. Each beam is collimated as described herein. As the beams reflect from different points on the curved surface, different portions of the beams, here illustrated as rays cross, and the narrowest cross section of the beams occurs at an exit pupil 121. In some examples, the exit pupil diameter is about 3.0 mm (again not drawn to scale).

Optical elements described herein may be made of glass or plastic material. Optical elements may be manufactured by molding, grinding and/or polishing. Optical elements may or may not be cemented to each other in embodiments. Optical elements described herein may be aspherical. In embodiments, single lens optical elements may be split into multiple lens elements. Better image quality may be achieved by replacing single lens optical elements with multiple lens optical elements so more lens are used and hence more properties are available to be varied to achieve a particular image quality.

FIG. 3C is a block diagram of another compact projection light engine 120a embodiment and waveguide 123 that may be disposed in a near-eye display. In an embodiment, waveguide 123 includes waveguides 475a-c illustrated in FIGS. 4A-B and as described herein. In an embodiment, projection light engine 120a shown in FIG. 3C operates similarly to projection light engine 120 shown in FIG. 3A. In an embodiment, projection light engine 120a includes illumination unit 222, lenticular screen 401, doublet 226, PBS 402, doublet 250, microdisplay 230, fold mirror 400, curved reflector 450 and quarter waveplate 236. In an embodiment, like reference numerals refer to similar components described herein. In alternate embodiment, more or less components may be used in projection light engine 120a.

In an embodiment, image light is projected from projection light engine 120a to an exit pupil 121 in waveguide 123. The waveguide 123 may then provide image light to eye space 140. In an embodiment, waveguide 123 includes rolled k-vector input diffraction gratings as described herein. Arrow 142 represents an optical axis of a near-eye display 14l. In an embodiment, an aperture of projection light engine 120a is 4 mm. In an embodiment, a projected exit pupil is 13 mm from the curved reflector 450.

In embodiments, components in projection light engine 120a are mounted on a common substrate, such as printed circuit board, in coplanar orientation. Other embodiments include other geometric orientations of components of projection light engine 120a. In an embodiment, projection light engine 120a has components that are at least partially coupled coplanar to a surface of a PCB.

In embodiments, curved reflector 450 provides focus control and may be a birdbath optical element having a curved reflector. In an embodiment, quarter waveplate 236 provides circular polarization. In an embodiment, two doublets are used and/or aspheric components are not used. In an embodiment, illumination unit 222 may include laser optics using prism injection or alternatively may be waveguided. In an embodiment, PBS 402 is disposed near microdisplay 230 that may maximize sequential contrast. In an embodiment, the microdisplay 230 has a surface 231 which reflects light from an illumination unit 222 for representing the image data to be displayed.

In an embodiment, projection light engine 120 does not include high index glass.

In an embodiment, one or more additional PBSs may be omitted from the projection light engine (such as optical directing element 224 that may be embodied as a PBS shown in FIG. 3A) which may reduce a number of components used, mass and optical total volume in projection light engine 120a as compared to projection light engine 120 shown in FIG. 3A, singly or in combination. In an embodiment, waveguide 123 having rolled k-vector input diffraction gratings may act similar to the omitted PBSs in splitting and polarizing light. In an embodiment, waveguide 123 is embedded in a projection light engine 120a and may fit in a gap between PBS 402 and curved reflector 450. In an embodiment, an optical total volume of projection light engine 120a may be approximately 1.2 cc.

An optical path of light through components in projection light engine 120a is discussed next. Different portions of the illumination light and image light are labeled with different numbers to facilitate discussing the progress of the light. To avoid overcrowding the drawing, only one representation ray of the beam is labeled at each stage of the path. Light 460 generated by the illumination unit 222 is directed through lenticular screen 401, doublet 226, PBS 402 and doublet 250 to a surface 231 of microdisplay 230. In an embodiment, lenticular screen 401 is a lens that may focus more of the light 460 into a horizontal beam. Light (or image light) 461 is then reflected from surface 231 through doublet 250 to PBS 402 that splits and polarizes image light 462 to fold mirror 400. Image light 463 is reflected from fold mirror 400 through quarter waveplate 236 to curved reflector 450. Image light 464 is reflected from curved reflector 450 and through quarter waveplate 236 to form an image (or portion thereof) at exit pupil 121 in waveguide 123. In an embodiment, image light 464 is diffracted by a first input diffraction grating in waveguide 123 while image light 463 is allowed to pass through the same first input diffraction grating un-deviated at approximately the same time from fold mirror 400. In an embodiment, waveguide 123 performs at least some of the functions of another PBS. In an embodiment, an external projected exit pupil is formed at eye space 140 as similar shown in FIG. 4A.

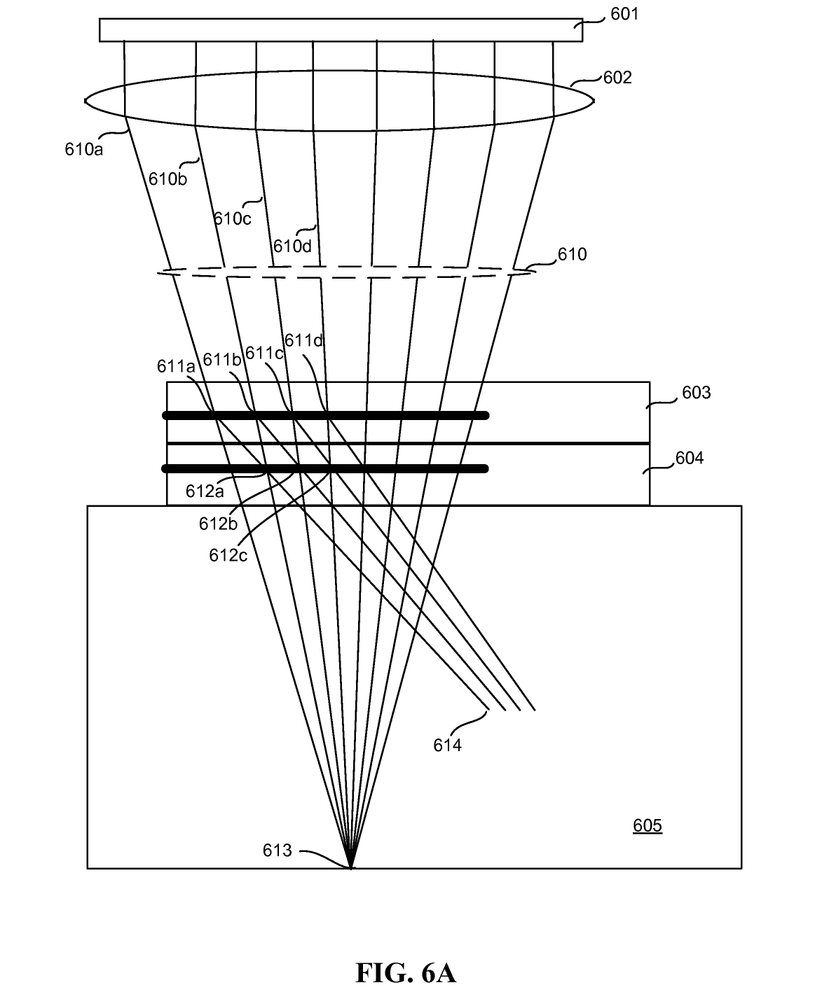

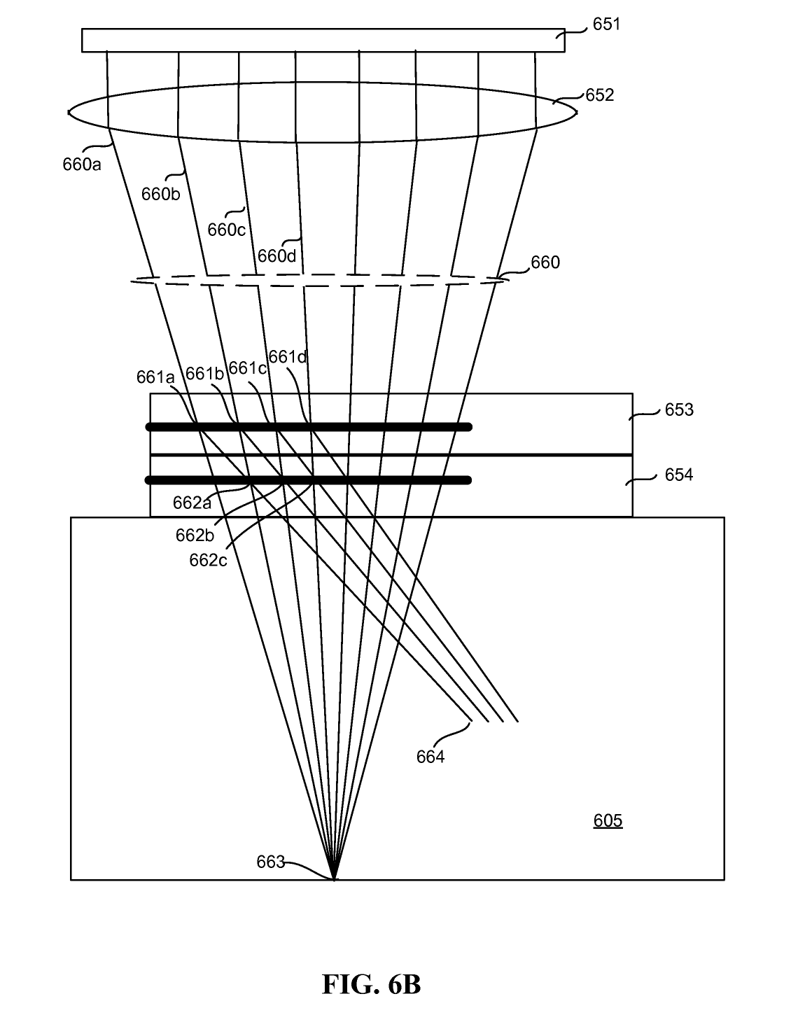

FIGS. 4A-B illustrate another embodiment of waveguide display including a compact projection light engine and multiple diffractive waveguides (or a waveguide stack). In particular, FIG. 4A illustrates a projection light engine 470 and multiple diffractive waveguides 475a-c (waveguide stack or diffraction waveguide). In an embodiment, one or more of diffractive waveguides 475a-c include one or more input diffraction gratings with rolled k-vectors as described herein. In embodiments, diffractive waveguides 475a-c replaces waveguide 123. In an embodiment, one or more diffractive waveguides 475a-c are manufactured as illustrated in FIGS. 6A-B and described herein. FIG. 4B illustrates a portion of the projection light engine 470 and diffractive waveguides 475a-c, shown in FIG. 4A, providing image light to a virtual or projected exit pupil 480 at eye space 140.

In an embodiment, projection light engine 470 operates similar to projection light engine 120 shown in FIG. 3A and projection light engine 120a shown in FIG. 3C. Also, projection light engine 470 has similar components as the embodiments shown in FIGS. 3A and 3C. However in an embodiment illustrated in FIGS. 4A-B, the angular bandwidth that an input diffraction grating (in diffractive waveguides 475a-c) supports may be less than in an embodiment where an input diffraction grating supports the whole display waveguide FOV. In an embodiment illustrated in FIGS. 4A-B, a waveguide display FOV is distributed over multiple input diffraction gratings in diffractive waveguides 475a-c so each input diffraction grating may support a fraction or a portion of the display waveguide FOV. In other words, the diffractive waveguide is included in a display that provides a FOV and the diffractive waveguide includes a first input diffraction grating that provides a portion of the FOV and a second input diffraction grating that provides a second portion of the FOV.

In an embodiment, the projection light engine 470 includes an image source or a microdisplay 471, such as a reflective LCoS microdisplay. In an embodiment, the microdisplay 471 has a surface 471a which reflects light from an illumination unit, such as illumination unit 222 shown in FIG. 3A, for representing the image data to be displayed. In addition, projection light engine 470 includes optical directing element 472 (such as a PBS), clean-up polarizer optical element 473 and doublet 474. In an embodiment, surface 471a polarizes image light it reflects; however there may be polarization errors. Clean-up polarizer optical element 473 corrects for polarizer errors of the LCoS surface after reflected image light is redirected by optical directing element 472. The doublet 474 corrects for chromatic aberration and also provides some collimation to the image light reflecting off the surface 471a. In an embodiment, doublet 474 may be a spherical doublet. Image light then passes to and from quarter waveplate 476. Image light is reflected from doublet/reflector 477 to quarter waveplate 476 and diffractive waveguides 475a-c to projected exit pupil 480. In an embodiment, doublet/reflector 477 includes a birdbath optical element having a curved reflector to reflect and collimate the image light from doublet 474. In an embodiment, doublet/reflector 477 also functions as a doublet.

An optical path of light through these elements in FIGS. 4A-B is discussed next. Different portions of the image light are labeled with different numbers to facilitate discussing the progress of the light. To avoid overcrowding the drawing, only two representative rays of the beam are labeled at each stage of the path and an illumination unit that may be used is not shown. In an embodiment, two representations of the beam (a first portion of the beam is represented by image light 481a-c and a second portion of the beam is represented by image light 482a-c) are the same beam. Image light 481a, that may be received from optical directing element 472 in an embodiment, is reflected from surface 471a. In an alternate embodiment, image light 481a originates from surface 471a. Optical directing element 472 redirects image light 481b through clean-up polarizer optical element 473, doublet 474 and directly un-deviated through a first input diffraction gratings of diffractive waveguides 475a-c and to external projected exit pupil 480 as illustrated by image lights 481b and 481c. In an embodiment, diffractive waveguides 475a-c outputs image light 482c that is reflected from doublet/reflector 477 through quarter waveplate 476 into the same first input diffraction gratings of diffractive waveguide 475a-c. Image light 482c is diffracted and is provided to external projected exit pupil 480. Image light 482c is a reflected version from doublet/reflector 477 of image light 482b that passes through quarter waveplate 476, doublet 474 and clean-up polarizer 473 in an embodiment. Image light 482a is reflected or originates from microdisplay 471 and is redirected as image light 482b from optical directing element 472. In an embodiment, image light 482a is received and reflected from optical directing element 472.

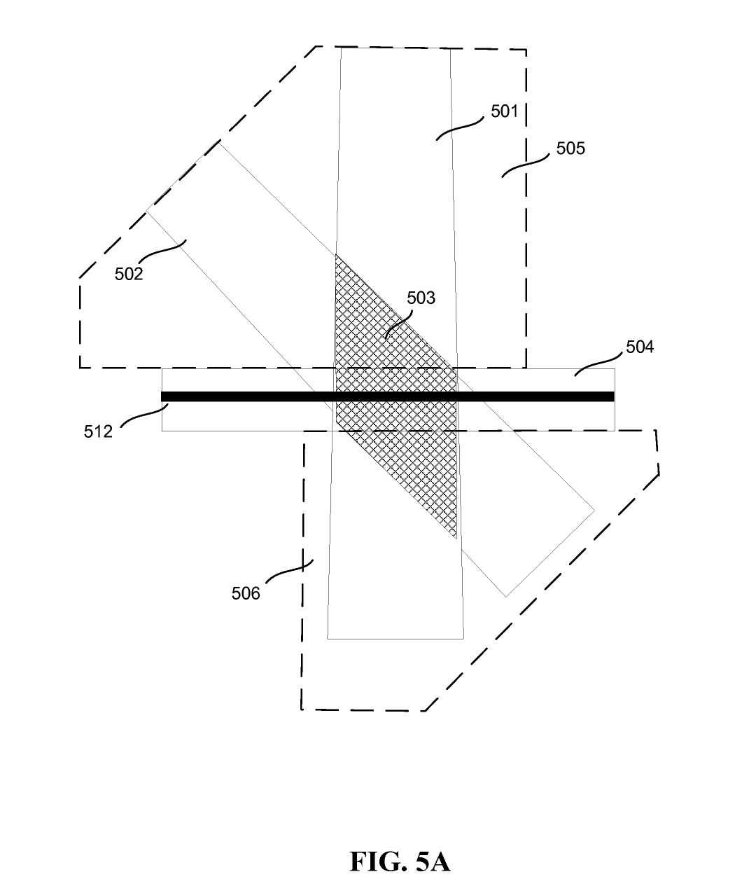

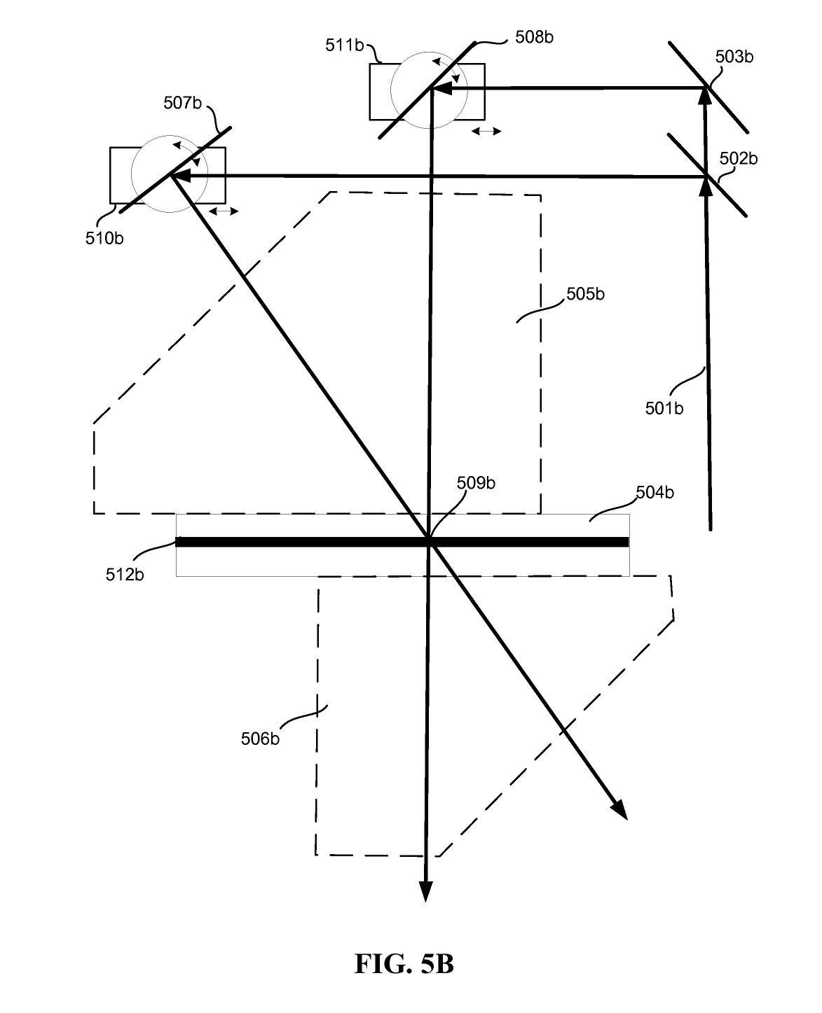

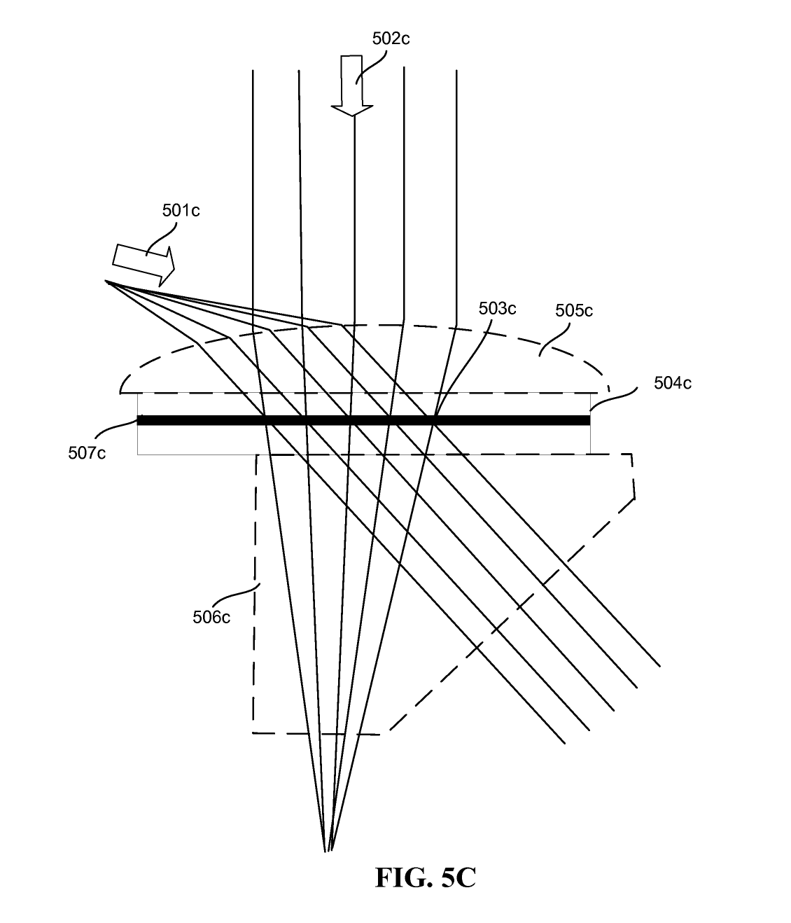

FIG. 5A illustrates an embodiment of providing a master hologram used to manufacture a copy substrate having input diffraction gratings with rolled (or different) k-vectors. The copy substrate formed by a master hologram, such as copy substrate 604 or 654 shown in FIGS. 6A-B, may be used as a layer in a diffractive waveguide. In an embodiment, a master substrate 504 having holographic recording material 512 is used to provide a master hologram, such as master holograms 603 and 653. In embodiments, a master substrate 504, and other master substrates, may include a stack or a plurality of substrates. In an embodiment, a master hologram may be manufactured so that the master hologram has a relatively high angular bandwidth, but not necessarily high diffraction efficiency. A copy substrate formed by using master hologram will be a contact copy having input diffraction gratings formed by rays of light that converge from incident rays on the master hologram. The converging rays of light from master hologram will enable the k-vector to change for each input diffraction grating on a copy substrate which may tune an angular bandwidth in line with input angles from a projection light engine, such as projection light engine 120a.

In an embodiment, at least two input diffraction gratings on a copy substrate, formed by a master hologram, have different associated k-vectors. In an embodiment, at least two adjacent input diffraction gratings on a copy substrate have respective associated k-vectors that are rolled or offset by a predetermined angle from each respective k-vector. In an embodiment, a master hologram is used to manufacture a copy substrate that receives light having a predetermined set of wavelengths.

At least two types of manufactured master holograms can support or be used in a rolled k-vector contact copy manufacture process as described herein. The first type is a master hologram with enough angular bandwidth to support the copy process for all copy beam angles. The second type of master hologram that can support a rolled k-vector contact copy process is a master hologram which in itself has a rolled k-vector. The first type of master hologram is recorded by a standard two beam recording process shown in FIG. 5A.

FIG. 5A illustrates forming a master hologram from a master substrate 504 having a holographic recording medium 512 by using two beams of light focused at infinity that are each projected to form a grating spacing. In an embodiment, two coherent plane laser beams 501 and 502 provide constructive interference 503 that form a master hologram from master substrate 504 having a holographic recording medium 512. In an embodiment, beam 501 is a reference beam. In an embodiment, reference beam 501 is defined by a chief ray direction of a projection light engine. In an embodiment, a chief ray direction from a projection light engine may be a direction perpendicular to an input surface of a waveguide. In an embodiment, beam 502 is a construction beam that is incident at an angle of the predetermined chief ray diffracted angle (an internal angle equating to the critical angle of a copy substrate plus approximately half a FOV in glass of a near-eye display in an embodiment).

To establish internal to glass angles, at least top and bottom sides (or portions thereof) of master substrate 504 are immersed in optical materials 505 and 506 (illustrated by dashed lines) with the index matching close to that of the master substrate 504. Without the addition of optical material 505 during recording, beam 502 would be beyond the critical angle of the material and the wave front of the incoming beam would overlap the reflected beam with undesirable holograms being generated. In order to avoid the second oblique beam reflecting internally due to total internal reflection at the bottom surface of master substrate 504, master substrate 504 is backed by optical material 506 with refractive index matching close to that of master substrate 504. This embodiment assumes that the recording wavelength is the same as the replay wavelength; the wavelength of the display or image light. If the recording wavelength is different than the wavelength of the display, the recording angles will need to be adjusted to optimize the efficiency of the display.

Forming a master hologram from master substrate 504 with sufficient angular bandwidth to support the angles of incidence of the copy beam may have the limitation that generally, for a given holographic recording medium, the larger the angular bandwidth, the lower the efficiency. In an embodiment, efficiency of a master hologram is 50% so that the two copy beams are balanced. If the master hologram efficiency is less then generally, the contact copy will not achieve the maximum modulation.

In an embodiment, a reflection edge coating is incorporated in between a master hologram and copy substrate. In an embodiment, a reflection edge coating may be incorporated between master hologram 603 and copy substrate 604 illustrated in FIG. 6A. The reflection edge coating will partially reflect the zero order; un-diffracted recording beam and transmit the diffracted beam from the master hologram. The reflection edge coating may be optimized so that the zero order beam intensity is the same as the diffracted copy beam. In an embodiment, a lot of the light for recording the copy substrate is thrown away leading to lengthening the recording process or may require a higher power Laser. This has economic implications in a production process.

The second type of master hologram that can support the contact copy process is a master hologram that has a fixed grating period but a rolled k-vector. There are at least two methods by which this type of master hologram can be formed. The first method is a scanning method illustrated in FIG. 5B. The second method illustrated in FIG. 5C includes using a set of two beam construction optics that can form a master hologram with a fixed grating period but with a rolled k-vector.

FIG. 5B illustrates a scanned beam recording method for recording a master hologram 504b with a fixed grating period but with a rolled k-vector from a master substrate 504b having holographic recording medium 512b. The Laser 501b is focused at infinity and is rectangular in cross section; wide in the direction into the page and narrow in the direction across the page. The Laser is split into two coherent beams at the beam splitter 502b and directed towards a mirror 507b for one beam and directed by second mirror 503b towards a third mirror 508b. Mirrors 507b and 508b are supported by separate linear stages and/or rotation stages (or stages) 510b and 511b respectively. These stages 510b and 511b are oriented horizontally above master substrate 504b. The rotation of the two stages 510b and 511b will reflect light of the two coherent beams to form the recording geometry of a master hologram required at point 509b. The stages 510b and 511b will be moved to ensure that the two beams perfectly overlap at point 509b.

The relative beam angles at substrate 504b achieve two conditions. The first condition is to form a grating period corresponding to the Bragg equation where the grating period is the same for all points of the grating. The second condition is to form a k-vector (in the direction corresponding to the bisector of the two beams). The desired k-vector is that which is optimized to support the angle range of display or image light from the projection light engine. To establish the required internal to glass angles, a top of master substrate 504b is immersed in an optical material 505b with the index matching close to that of master substrate 504b. In order to avoid the second oblique beam reflecting internally due to total internal reflection at a bottom surface of master substrate 504b, master substrate 504b is backed by optical material 506b with refractive index matching close to that of master substrate 504b. The master substrate 504b incorporates a holographic recording medium 512b. The precise layout of the stack depends on the holographic recording medium. In an embodiment, a liquid such as dichromated gelatin or liquid version of photopolymer is used as a holographic recording medium 512b and would be sandwiched between two substrates as illustrated in FIG. 5B.

In an embodiment, a scanning method for recording the master hologram 504b illustrated in FIG. 5B enables new master prescriptions to be programmed very quickly and the cost of the mastering process relatively low. In an embodiment, this scanning method may have edge effects recorded in the master hologram due to the piece-wise process of recording the master hologram and the potential that the first and second beams are not perfectly overlapped. These effects would generally be local efficiency variations in the master hologram and which potentially get recorded in the copy process.

FIG. 5C illustrates a two beam recording of a master hologram that has a constant grating period but varying k-vector. The wave fronts required for the first and second beam 501c and 502c respectively are predetermined by ray tracing methods as known by one of ordinary skill in the art. The interference of these two beams at point 503c in the holographic recording medium 507c establish the grating period and the k-vector of the master hologram. As in the previous embodiments, to establish the internal to glass angles, top and bottom surfaces of master substrate 504c are immersed in optical material 505c and 505c (illustrated by dashed lines) with the index matching close to that of the master substrate 504c. In an embodiment, optical material 505c can be an optically powered material where the optical power of the optical material 505c is shared between the recording beams 501c and 502c. In this embodiment, construction optics may be more compact and optical material 505c may be more compact than in other embodiments. In order to avoid the second oblique beam reflecting internally due to total internal reflection at a bottom surface of master substrate 504, master substrate 504 is backed by optical material 506c with refractive index matching close to that of master substrate 504.

The construction optics for beam 501c and 502c may be designed by ray tracing methods as known by one of ordinary skill in the art. In an embodiment, construction beams 501c and 502c may include a series of optical components that can generate these wave fronts. In an embodiment, these optical components may include, but not limited to, lenses, cylinders, aspheric lenses, and/or diffractive optical components including computer generated holograms. In an embodiment, using a two beam process for recording a master hologram with constant grating period but rolling k-vector may be more efficient that the method illustrated in FIG. 5B. In an embodiment, a method illustrated by FIG. 5C may have complex optics that may be regenerated when a design of the display is changed. In an embodiment, a method illustrated in FIG. 5B is used to build a prototype master hologram and a method illustrated in FIG. 5C is used to build a master hologram used for manufacturing products, and in particular diffractive waveguides as described herein.

FIGS. 6A-B illustrates a method embodiment of manufacturing one or more copy substrates that may be used in a diffractive waveguide having input diffraction gratings with rolled k-vectors. Dimensions illustrated in FIGS. 6A-B are not to scale. In an embodiment, a master hologram formed from master substrate 504 shown in FIG. 5A may be used to form a copy substrate 604 illustrated in FIG. 6A. In an embodiment, a master hologram formed from master substrate 504 shown in FIG. 5A is used as master hologram 603 illustrated in FIG. 6A. In alternate embodiments, master holograms formed from master substrates illustrated in FIGS. 5B-C may be used to form copy substrates illustrated in FIGS. 6A-B.

In an embodiment, copy substrate 604 is used as a layer, such as layer 256 in an embodiment, in a diffractive waveguide shown in FIGS. 3A-C. In an embodiment, copy substrate 604 receives light having a first set of wavelengths while copy substrate 654 (which may correspond to layer 258 in an embodiment) shown in FIG. 6B receives light having a second different set of wavelengths. In an embodiment, input diffraction gratings are formed in copy substrates 604 and 654 using birefringent materials, such as liquid crystals. Birefringent materials may be efficient for one orientation of polarization of image light that may enable the assembled copy substrates forming a multi-layer diffractive waveguide function more efficiently as another PBS.

In an embodiment, a master hologram 603 is disposed on a copy substrate 604. Master hologram 603 and copy substrate 604 are supported by a structure 605. A light source 601 provides a beam of light 610 including rays of lights 610a-d (or rays 610a-d) to input diffraction gratings 611a-d of master hologram 603. In an embodiment, input diffraction gratings 611a-d of master hologram 603 are formed as described herein. In an embodiment, beam 610 passes through focusing lens 602 that may include aspheric correction to generate an optimized wave front to maximize the efficiency of the copy hologram matched to the angles required in the display input diffraction grating.

Optical paths of beam 610 illustrated in FIG. 6A are now described. In an embodiment, a ray 610a travels along a first un-diffracted optical path (zero order diffraction mode) through master hologram 603 at input diffraction grating 611a and copy substrate 604. Ray 610a is also diffracted by master hologram 603 at input diffraction grating 611a (first order diffraction mode) along a second optical path to form a beam at point 612a. This beam represents one of the beams that will form an interference pattern in the copy substrate. A third beam (or ray) 610b travels along a first un-diffracted path or third optical path through the master hologram at input diffraction grating 611b to the copy substrate at point 612a. This forms the second beam that forms an interference pattern in the copy substrate. The interference pattern of the first and second beam will be recorded in the copy substrate and form part of the input diffraction grating of the display. The interference of the un-diffracted beam and the diffracted beam from the master hologram will continue across the copy substrate to form the final hologram for the input diffraction grating of the display. Since the input beam 610 is converging to a point 613, the interference is caused by two wave fronts that are generally rolling in angle. Hence the k-vector of the copy hologram will be rolling.

Other input diffraction gratings are similar formed as illustrated in FIG. 6A. In particular, ray 610b is also diffracted along a fourth optical path at input diffraction grating 611b to form input diffraction grating 612b with ray 610c along a fifth optical path entering at input diffraction grating 611c and passing though copy substrate 604 to point 613. Input diffraction grating 612c is similarly formed with a diffracted ray 610c along a sixth optical path to converging beam 614 and ray 610d along a seventh optical path passing through master hologram 603 at input diffraction grating 611d to form input diffraction grating 612c and travel to point 613.

FIG. 6B illustrates a method embodiment of manufacturing a second different copy substrate 654 that may be used in a diffractive waveguide having input diffraction gratings with rolled (or different) k-vectors. In an embodiment, a master hologram 653 is disposed on a copy substrate 654. Master hologram 653 and copy substrate 654 are supported by a structure 605. A light source 651 provides a beam of light 660 including rays of lights 660a-d (or rays 660a-d) to input diffraction gratings 661a-d of master hologram 653. In an embodiment, light source 651 is a different light source than light source 601. In an embodiment, input diffraction gratings 661a-d of master hologram 653 are formed as described herein. In an embodiment, beam of light 660 passes through focusing lens 652.

Input gratings 662a-c of copy substrate 654 are formed by optical paths of beam of light 660 similar to input diffraction gratings 612a-c described herein. Beam of light 660 may be directed to a point 663 and also converging beam 664 as similar described with regard to point 613 and converging beam 614 illustrated in FIG. 6A. Each input diffraction gratings 662a-c may have different k-vectors or rolled k-vectors in embodiments.

As can be seen by the geometry of FIGS. 6A-B, there is a distance between a master hologram and a copy substrate during manufacturing (for example, the distance between input gratings 611b and 612a) so the manufactured copy substrate may have some optical power. In an embodiment, the optical power in copy substrate 604 varies from one side (or input diffraction grating) to the other side (or next adjacent input diffraction grating). The optical power may be off-axis and may induce aberrations in the light entering a waveguide having copy substrate 604 (for example, the light in the waveguide may not be collimated properly).

To compensate this a corrective lens or aspheric element may be disposed in a projection light engine (or external to a waveguide having the copy substrate) to compensate for the light aberrations.

In an embodiment, copy substrates 604 and 654 may be coupled to form a multi-layer diffractive waveguide, such as waveguide 123. In an embodiment copy substrates 604 and 654 may be coupled or stacked at ends with an adhesive, cement, or other bonding material (or device) that allows an air gap between copy substrate surfaces having input gratings.

FIG. 7 illustrates an embodiment of a left side housing 130l for positioning an embodiment of a projection light engine 120 with an external exit pupil for optical coupling with a near-eye display in a NED device using an eyeglass frame. The left side housing 130l is also referred to as the housing of a projection light engine. This view illustrates an example of how projection light engine components may be fitted within the left side housing 130l. A protective covering is removed to see the exemplary arrangement. In alternate embodiments, projection light engine components may be disposed in a different arrangement and/or orientation so as to fit a different sized housing. For example, components of a projection light engine may be disposed in a coplanar orientation on a PCB as illustrated in FIG. 4.

The left side housing 130l is connected and adjacent to frame top section 117 and left side arm 102l as well as a portion of frame 115 surrounding a left side display unit 112. In this example, a power supply feed 291 is located on the upper left interior of left side housing 130l providing power from power supply 239 for various components. Throughout left side housing 130l are various exemplary electrical connections 228 (228a, 228b, 228c, 228d, and 228e) for providing power as well as data representing instructions and values to the various components. An example of an electrical connection is a flex cable 228b which interfaces with the control circuitry 136 which may be inside the frame top section 117 as in FIG. 1 or elsewhere such as on or within a side arm 102.

Starting in the lower left is a housing structure 222h which encompasses components within the three dimensional space surrounded by the dashed line representing housing structure 222h. Housing structure 222h provides support and a protective covering for components of the illumination unit 222 (such as the one or more light sources of illumination unit 222) and at least display illumination driver 247. Display illumination driver 247 convert digital instructions to analog signals to drive one or more light sources like lasers or LEDs making up the illumination unit 222. Flex cable 228c also provides electrical connections. In this embodiment, the illumination is directed onto an optical directing element 227 (represented as a dashed line) such as a mirror, which is within an optical system housing 220h. Additional elements, like another polarizer, may follow between the optical directing element 227 and optical directing element 224 also (represented as a dashed line) within the optical system housing 220h.

The optical system housing 220h includes components of a projection optical system 220 such as the embodiments described herein. In this embodiment, optical system housing 220h below dashed line 290 extending to arrow 294 and including its section which extends slightly above the dashed line 290 as indicated by arrow 298 and which extends left as indicated by arrow 296, immerses the components in high index glass. In this view of the optical system housing 220h, the illumination reflected from optical directing element 227 is directed to optical directing element 224 which directs light through doublet 226 in the doublet housing 226h to a microdisplay 230 positioned by chip housing 230h which is disposed above doublet 226. The light reflected from the microdisplay 230 (as in the embodiment illustrated by FIG. 3A) is polarized and reflected to the birdbath optical element 234 (shown as a dashed line circle in FIG. 7). The back of the curved reflective surface 238 of the birdbath optical element 234 is facing out of the page in this view. The reflected image light is reflected into the page where a portion of the waveguide 123 (not shown) with one or more input diffraction gratings extends to the left of the display unit 112 and behind optical system housing 220h in this view in order to couple the image light of the external exit pupil 121 (not shown).

In some embodiments, the distance from the top of the chip housing 230h to the vertical bottom of optical system housing 220h indicated by arrow 294 is within 20 millimeters. In an embodiment, such distance is about 17 mm. The components arranged in such an embodiment include microdisplay 230, optical compensator 228, doublet 226, optical directing element 224, optical directing element 232, birdbath optical element 234 and the quarter waveplate 236 (as arranged in the embodiment of FIG. 3A). Additionally, optical system housing 220h from its leftmost side 296 to the right side at arrow 292 extends within about 30 millimeters in an embodiment.

In alternate embodiments, the electronics and optical elements shown in FIG. 7 (or described herein) may be disposed in an alternative orientation or arrangement with one or more different or combined supporting housings and/or structures. In alternate embodiments, aspheric elements and/or aspheric meniscus lens may be disposed in left side housing 130l and/or external to left side housing 130l.

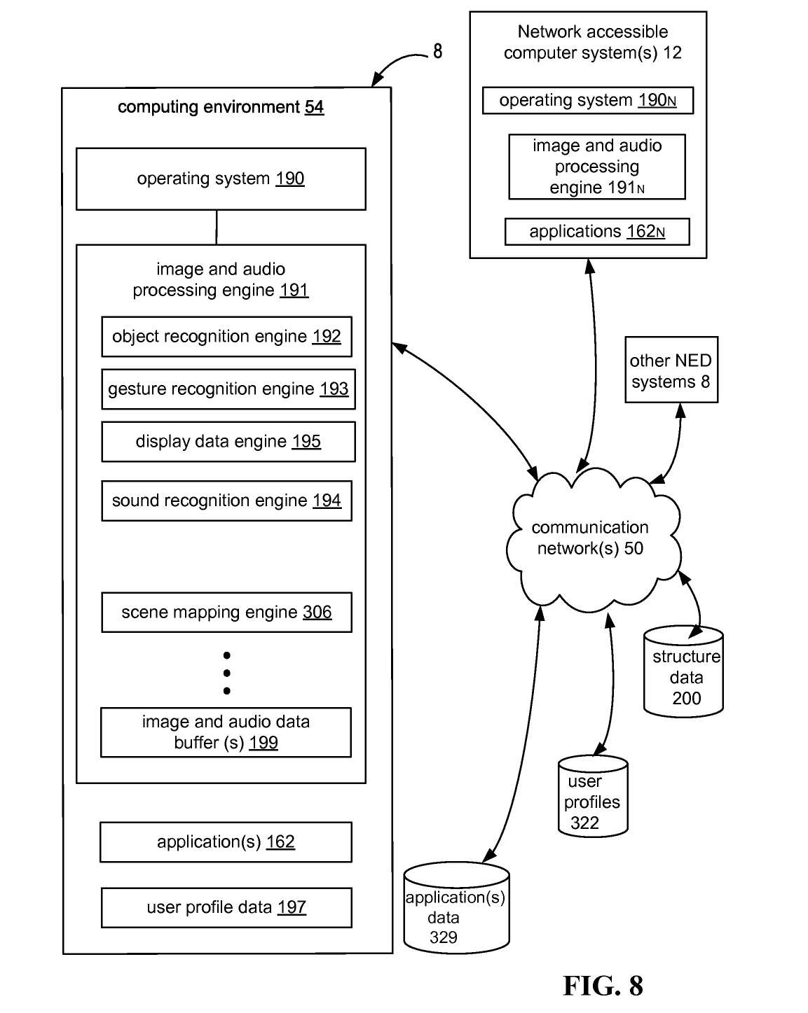

FIG. 8 is a block diagram of an embodiment of a system from a software perspective for displaying image data or light (such as a computer generated image (CGI)) by a near-eye display device. FIG. 8 illustrates an embodiment of a computing environment 54 from a software perspective which may be implemented by a system like NED system 8, network accessible computing system(s) 12 in communication with one or more NED systems or a combination thereof. Additionally, a NED system can communicate with other NED systems for sharing data and processing resources.

As described herein, an executing application determines which image data is to be displayed, some examples of which are text, emails, virtual books or game related images. In this embodiment, an application(s) 162 may be executing on one or more processors of the NED system 8 and communicating with an operating system 190 and an image and audio processing engine 191. In the illustrated embodiment, a network accessible computing system(s) 12 may also be executing a version 162N of the application as well as other NED systems 8 with which it is in communication for enhancing the experience.

Application(s) 162 includes a game in an embodiment. The game may be stored on a remote server and purchased from a console, computer, or smartphone in embodiments. The game may be executed in whole or in part on the server, console, computer, smartphone or on any combination thereof. Multiple users might interact with the game using standard controllers, computers, smartphones, or companion devices and use air gestures, touch, voice, or buttons to communicate with the game in embodiments.

Application(s) data 329 for one or more applications may also be stored in one or more network accessible locations. Some examples of application(s) data 329 may be one or more rule data stores for rules linking action responses to user input data, rules for determining which image data to display responsive to user input data, reference data for natural user input like for one or more gestures associated with the application which may be registered with a gesture recognition engine 193, execution criteria for the one or more gestures, voice user input commands which may be registered with a sound recognition engine 194, physics models for virtual objects associated with the application which may be registered with an optional physics engine (not shown) of the image and audio processing engine 191, and object properties like color, shape, facial features, clothing, etc. of the virtual objects and virtual imagery in a scene.

As shown in FIG. 8, the software components of a computing environment 54 comprise the image and audio processing engine 191 in communication with an operating system 190. The illustrated embodiment of an image and audio processing engine 191 includes an object recognition engine 192, gesture recognition engine 193, display data engine 195, a sound recognition engine 194, and a scene mapping engine 306. The individual engines and data stores provide a supporting platform of data and tasks which an application(s) 162 can leverage for implementing its one or more functions by sending requests identifying data for processing and receiving notification of data updates. The operating system 190 facilitates communication between the various engines and applications. The operating system 190 makes available to applications which objects have been identified by the object recognition engine 192, gestures the gesture recognition engine 193 has identified, which words or sounds the sound recognition engine 194 has identified, and the positions of objects, real and virtual from the scene mapping engine 306.

The computing environment 54 also stores data in image and audio data buffer(s) 199 which provide memory for image data and audio data which may be captured or received from various sources as well as memory space for image data to be displayed. The buffers may exist on both the NED, e.g. as part of the overall memory 244, and may also exist on the companion processing module 4.

In many applications, virtual data (or a virtual image) is to be displayed in relation to a real object in the real environment. The object recognition engine 192 of the image and audio processing engine 191 detects and identifies real objects, their orientation, and their position in a display FOV based on captured image data and captured depth data from outward facing image capture devices 113 if available or determined depth positions from stereopsis based on the image data of the real environment captured by the capture devices 113. The object recognition engine 192 distinguishes real objects from each other by marking object boundaries, for example using edge detection, and comparing the object boundaries with structure data 200. Besides identifying the type of object, an orientation of an identified object may be detected based on the comparison with stored structure data 200. Accessible over one or more communication network(s) 50, structure data 200 may store structural information such as structural patterns for comparison and image data as references for pattern recognition. Reference image data and structural patterns may also be available in user profile data 197 stored locally or accessible in Cloud based storage.

The scene mapping engine 306 tracks the three dimensional (3D) position, orientation, and movement of real and virtual objects in a 3D mapping of the display FOV. Image data is to be displayed in a user's FOV or in a 3D mapping of a volumetric space about the user based on communications with the object recognition engine 192 and one or more executing application(s) 162 causing image data to be displayed.

An application(s) 162 identifies a target 3D space position in the 3D mapping of the display FOV for an object represented by image data and controlled by the application. For example, the helicopter shoot down application identifies changes in the position and object properties of the helicopters based on the user's actions to shoot down the virtual helicopters. The display data engine 195 performs translation, rotation, and scaling operations for display of the image data at the correct size and perspective. The display data engine 195 relates the target 3D space position in the display FOV to display coordinates of the display unit 112. For example, the display data engine may store image data for each separately addressable display location or area (e.g. a pixel, in a Z-buffer and a separate color buffer). The display driver 246 translates the image data for each display area to digital control data instructions for microdisplay circuitry 259 or the display illumination driver 247 or both for controlling display of image data by the image source.

The technology described herein may be embodied in other specific forms or environments without departing from the spirit or essential characteristics thereof. Likewise, the particular naming and division of modules, engines routines, applications, features, attributes, methodologies and other aspects are not mandatory, and the mechanisms that implement the technology or its features may have different names, divisions and/or formats.

The technology described herein may be embodied in a variety of operating environments. For example, NED system 8 and/or network accessible computing system(s) 12 may be included in an Internet of Things (IoT) embodiment. The IoT embodiment may include a network of devices that may have the ability to capture information via sensors. Further, such devices may be able to track, interpret, and communicate collected information. These devices may act in accordance with user preferences and privacy settings to transmit information and work in cooperation with other devices. Information may be communicated directly among individual devices or via a network such as a local area network (LAN), wide area network (WAN), a “cloud” of interconnected LANs or WANs, or across the entire Internet. These devices may be integrated into computers, appliances, smartphones wearable devices, implantable devices, vehicles (e.g., automobiles, airplanes, and trains), toys, buildings, and other objects.

The technology described herein may also be embodied in a Big Data or Cloud operating environment as well. In a Cloud operating environment, information including data, images, engines, operating systems, and/or applications described herein may be accessed from a remote storage device via the Internet. In an embodiment, a modular rented private cloud may be used to access information remotely. In a Big Data operating embodiment, data sets have sizes beyond the ability of typically used software tools to capture, create, manage, and process the data within a tolerable elapsed time. In an embodiment, image data may be stored remotely in a Big Data operating embodiment.

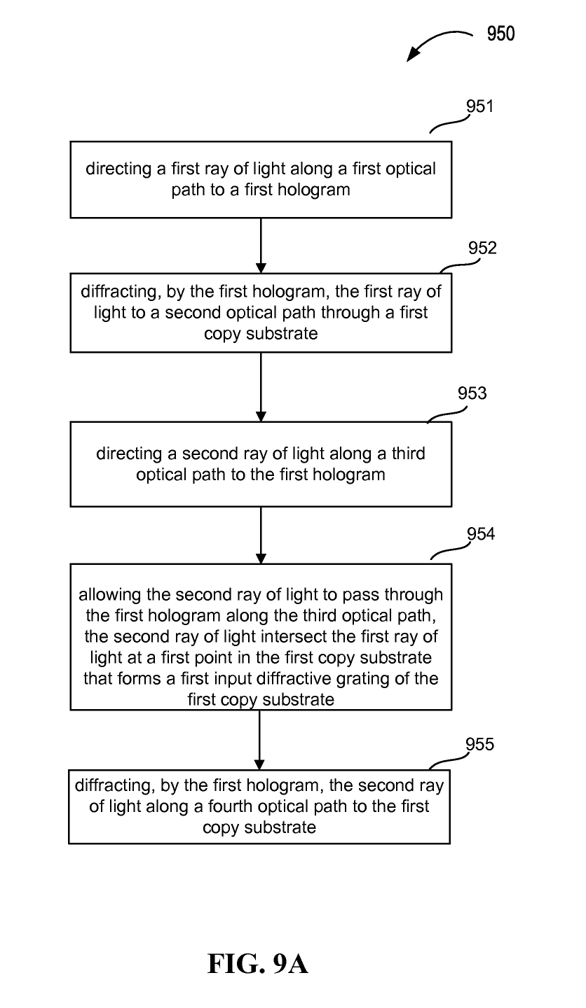

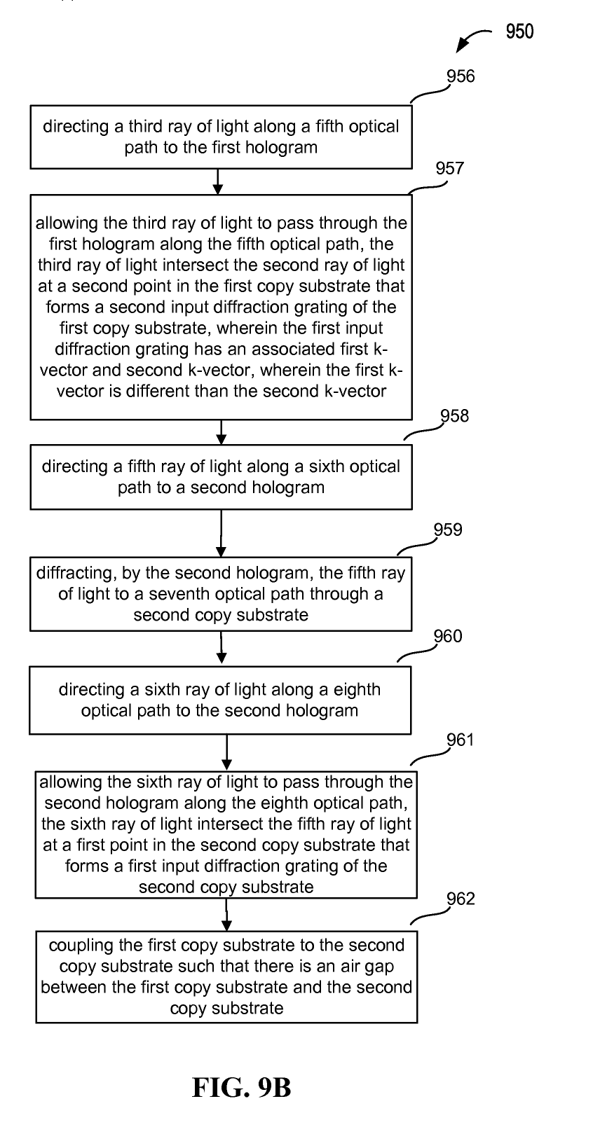

FIGS. 9A-B is flowchart of a method embodiment for manufacturing a diffractive waveguide having input diffraction gratings, such as rolled k-vector input diffraction gratings. The steps illustrated in FIGS. 9A-B may be performed by optical elements, hardware components and software components, singly or in combination. The steps illustrated in FIGS. 9A-B may be performed by a variety of different types of manufacturing steps, such as a semiconductor processing step. For illustrative purposes, the method embodiments described herein may provide a diffractive waveguide that may be used in the context of the system and apparatus embodiments described herein. However, the method embodiments and resulting diffractive waveguide having particular input diffraction gratings are not limited to operating in the system embodiments described herein and may be implemented in other system embodiments.

In an embodiment, steps 951-957 described below and shown in FIGS. 9A-B illustrate manufacturing at least two rolled (or different) k-vector input diffraction gratings in a first copy substrate, or layer of a diffractive waveguide, as shown in FIG. 6A. In another embodiment, steps 958-962 described below and shown in FIG. 9B illustrate manufacturing at least two rolled (or different) k-vector input diffraction gratings in a second copy substrate, or second layer of a diffractive waveguide, as shown in FIG. 6B.

Step 951, of method 950, begins by directing a first ray of light along a first optical path to a first hologram. In an embodiment, the first ray of light corresponds to ray 610a from light source 601 and lens 602 shown in FIG. 6A. In an embodiment, the first hologram corresponds to master hologram 603.

Step 952 illustrates diffracting, by the first hologram, the first ray of light to a second optical path through a first copy substrate. In an embodiment, the first ray of light is diffracted from input diffraction grating 611a in master hologram 603 to point 612a in copy substrate 604.

Step 953 illustrates directing a second ray of light along a third optical path to the first hologram. In an embodiment, the second ray of light corresponds to ray 610b from light source 601 and lens 602 shown in FIG. 6A.

Step 954 illustrates allowing the second ray of light to pass through the first hologram along the third optical path, the second ray of light intersect the first ray of light at a first point in the first copy substrate that forms a first input diffraction grating of the copy substrate. In an embodiment, the first point in the first copy substrate corresponds to input diffraction grating 612a as shown in FIG. 6A.

Step 955 illustrates diffracting, by the first hologram, the second ray of light along a fourth optical path to the first copy substrate. In an embodiment, the second ray of light is diffracted from input diffraction grating 611b in master hologram 603 to input diffraction grating 612b in copy substrate 604. In an embodiment, steps

Step 956, shown in FIG. 9B, illustrates directing a third ray of light along a fifth optical path to the first hologram. In an embodiment, the third ray corresponds to ray 610c shown in FIG. 6A.

Step 957 illustrates allowing the third ray of light to pass through the first hologram along the fifth optical path so that the third ray of light intersect the second ray of light at a second point in the first copy substrate that forms a second input diffraction grating of the first copy substrate. Step 957 further illustrates that the first input diffraction grating has an associated first k-vector and second different k-vector. In an embodiment, the second point in the second copy substrate corresponds to input diffraction grating 612b. In alternate embodiments, at least two of the steps described above may be repeated to form more input diffraction gratings on a first copy substrate, such as at input diffraction grating 612c shown in FIG. 6A.

Step 958 illustrates directing a fifth ray of light along a sixth optical path to a second hologram. In an embodiment, the fifth ray of light corresponds to ray 660a from light source 651 and lens 652 shown in FIG. 6B. In an embodiment, the second hologram corresponds to hologram master 653.

Step 959 illustrates diffracting, by the second hologram, the fifth ray of light to a seventh optical path through a second copy substrate. In an embodiment, the fifth ray of light is diffracted from input diffraction grating 661a in master hologram 653 to input diffraction grating 662a in copy substrate 654.

Step 960 illustrates directing a sixth ray of light along an eighth optical path to the second hologram. In an embodiment, the sixth ray of light corresponds to ray 660b from light source 651 and lens 652 shown in FIG. 6B.

Step 961 illustrates allowing the sixth ray of light to pass through the second hologram along the eighth optical path so that the sixth ray of light intersect the fifth ray of light at a first point in the second copy substrate that forms a first input diffraction grating of the second copy substrate. In an embodiment, the first point in the second copy substrate corresponds to input diffraction grating 662a as shown in FIG. 6B. In alternate embodiments, at least two of the steps described above may be repeated to form more input diffraction gratings on a second copy substrate, such as at input diffraction grating 662b-c shown in FIG. 6B.

Step 962 illustrates coupling the first copy substrate to the second copy substrate such that there is an air gap between the first copy substrate and the second copy substrate. In an embodiment, an adhesive material may be used to couple the copy substrates. In an embodiment, the first copy substrate corresponds to layer 256 and the second copy substrate corresponds to layer 258 shown in FIGS. 3A-B.

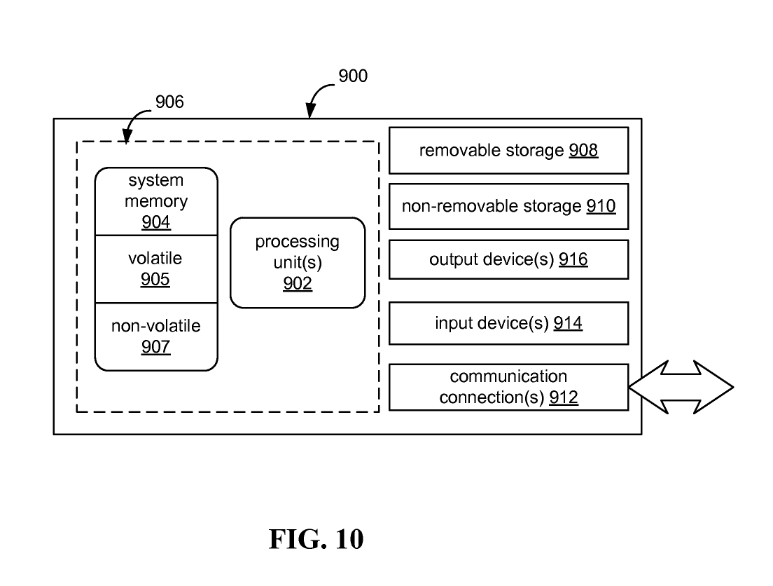

FIG. 10 is a block diagram of an exemplary computing system 900 (also referred to as a computer system) that can be used to implement a network accessible computing system(s) 12, a companion processing module 4, or another embodiment of control circuitry 136 of a HMD 2. Computing system 900 may host at least some of the software components of computing environment 54. In an embodiment, computing system 900 may include a Cloud server, server, client, peer, desktop computer, laptop computer, hand-held processing device, tablet, smartphone and/or wearable computing/processing device.

In its most basic configuration, computing system 900 typically includes one or more processing units (or cores) 902 or one or more central processing units (CPU) and one or more graphics processing units (GPU). Computing system 900 also includes memory 904. Depending on the exact configuration and type of computing system, memory 904 may include volatile memory 905 (such as RAM), non-volatile memory 907 (such as ROM, flash memory, etc.) or some combination thereof. This most basic configuration is illustrated in FIG. 10 by dashed line 906.

Additionally, computing system 900 may also have additional features/functionality. For example, computing system 900 may also include additional storage (removable and/or non-removable) including, but not limited to, magnetic or optical disks or tape. Such additional storage is illustrated in FIG. 10 by removable storage 908 and non-removable storage 910.

Alternatively, or in addition to processing unit(s) 902, the functionally described herein can be performed or executed, at least in part, by one or more other hardware logic components. For example, and without limitation, illustrative types of hardware logic components that can be used include Field-programmable Gate Arrays (FPGAs), Program Application-specific Integrated Circuits (ASICs), Program Application-specific Standard Products (ASSPs), System-on-a-chip systems (SOCs), Complex Programmable Logic Devices (CPLDs) and other like type of hardware logic components.

Computing system 900 may also contain communication module(s) 912 including one or more network interfaces and transceivers that allow the device to communicate with other computing systems. Computing system 900 may also have input device(s) 914 such as keyboard, mouse, pen, microphone, touch input device, gesture recognition device, facial recognition device, tracking device or similar input device. Output device(s) 916 such as a display, speaker, printer, or similar output device may also be included.

A user interface (UI) software component to interface with a user may be stored in and executed by computing system 900. In an embodiment, computing system 900 stores and executes a natural language user interface (NUI) and/or 3D UI. Examples of NUIs include using speech recognition, touch and stylus recognition, gesture recognition both on screen and adjacent to the screen, air gestures, head and eye tracking, voice and speech, vision, touch, hover, gestures, and machine intelligence. Specific categories of NUI technologies include for example, touch sensitive displays, voice and speech recognition, intention and goal understanding, motion gesture detection using depth cameras (such as stereoscopic or time-of-flight camera systems, infrared camera systems, RGB camera systems and combinations thereof), motion gesture detection using accelerometers/gyroscopes, facial recognition, 3D displays, head, eye, and gaze tracking, immersive augmented reality and virtual reality systems, all of which may provide a more natural interface, as well as technologies for sensing brain activity using electric field sensing electrodes (EEG and related methods).

A UI (including a NUI) software component may be at least partially executed and/or stored on a local computer, tablet, smartphone, NED device system. In an alternate embodiment, a UI may be at least partially executed and/or stored on server and sent to a client. The UI may be generated as part of a service, and it may be integrated with other services, such as social networking services.

The example computing systems illustrated in the figures include examples of computer readable storage devices. A computer readable storage device is also a processor readable storage device. Such devices may include volatile and nonvolatile, removable and non-removable memory devices implemented in any method or technology for storage of information such as computer readable instructions, data structures, program modules or other data. Some examples of processor or computer readable storage devices are RAM, ROM, EEPROM, cache, flash memory or other memory technology, CD-ROM, digital versatile disks (DVD) or other optical disk storage, memory sticks or cards, magnetic cassettes, magnetic tape, a media drive, a hard disk, magnetic disk storage or other magnetic storage devices, or any other device which can be used to store the information and which can be accessed by a computing system.

### Aspects of Certain Embodiments

One or more embodiments include an apparatus comprising an apparatus comprising a polarizing beam splitter to output image light and a microdisplay to reflect the image light from the polarizing beam splitter back to the polarizing beam splitter that redirects the image light as redirected image light. A diffractive waveguide having an input diffraction grating to receive the redirected image light from the polarizing beam splitter. The redirected image light from the polarizing beam splitter passes through the input diffraction grating un-deviated. A quarter waveplate receives the redirected image light from the polarizing beam splitter and outputs the redirected image light. A curved reflector receives the redirected image light from the quarter waveplate. The curved reflector reflects and collimates the redirected image light back to the quarter waveplate that outputs the redirected image light to the input diffraction grating. The redirected image light from the quarter waveplate is diffracted by the input diffraction grating.

In an apparatus embodiment, wherein the diffractive waveguide is included in a display that provides a field of view, wherein the diffractive waveguide includes the input diffraction grating that provides a portion of the field of view and another input diffractive grating that provides a second portion of the field of view.

In an embodiment, wherein the diffractive waveguide performs at least a function of another polarizing beam splitter.

In an embodiment, the apparatus further comprising a clean-up polarizer to receive the redirected image light from the polarizing beam splitter and output the redirected image light and a doublet to receive the redirected image light from the clean-up polarizer and output the redirected image light to the diffractive waveguide.

In an embodiment, wherein at least a portion of the polarizing beam splitter, microdisplay, curved reflector and quarter waveplate are coplanar and/or disposed on a printed circuit board.

In an embodiment, the apparatus further comprises a diffractive waveguide including a plurality of layers. The quarter waveplate outputs the redirected image light through the diffraction waveguide to a projected exit pupil.

In an embodiment, a first layer, in the plurality of layers, includes the input diffraction grating having a first k-vector and a second layer in the plurality of layers having another input diffraction grating having a second k-vector. The first k-vector is different than the second k-vector.

In an embodiment, the apparatus is included in a near-eye display device having a projection light engine and near-eye display. The projection light engine includes the microdisplay, polarizing beam splitter, curved reflector and quarter waveplate. The near-eye display includes the diffractive waveguide.

One or more embodiments include a method comprising directing a first ray of light along a first optical path to a first hologram. The first hologram diffracts the first ray of light to a second optical path through a first copy substrate. A second ray of light is directed along a third optical path to the first hologram. The second ray of light is allowed to pass through the first hologram along the third optical path. The second ray of light intersect the first ray of light at a first point in the first copy substrate that forms a first input diffraction grating of the first copy substrate.

In an embodiment, the method further comprises diffracting, by the first hologram, the second ray of light along a fourth optical path to the first copy substrate. A third ray of light is directed along a fifth optical path to the first hologram. The third ray of light is allowed to pass through the first hologram along the fifth optical path. The third ray of light intersect the second ray of light at a second point in the first copy substrate that forms a second input diffraction grating of the first copy substrate The first input diffraction grating has an associated first k-vector and second k-vector, wherein the first k-vector is different than the second k-vector.

In an embodiment, the method further comprises directing a fifth ray of light along a sixth optical path to a second hologram. The second hologram diffracts the fifth ray of light to a seventh optical path through a second copy substrate. A sixth ray of light is directed along an eighth optical path to the second hologram. The sixth ray of light is allowed to pass through the second hologram along the eighth optical path. The sixth ray of light intersect the fifth ray of light at a first point in the second copy substrate that forms a first input diffraction grating of the second copy substrate.

In an embodiment, the first hologram is associated with a first light having a first set of wavelengths and the second hologram is associated with a second slight having a second set of wavelengths.

In an embodiment, the method comprises coupling the first copy substrate to the second copy substrate such that there is an air gap between the first copy substrate and the second copy substrate.

In an embodiment, the first copy substrate and second copy substrate form a first and second layer of a multi-layer diffractive waveguide used in a near-eye display that receives image light at an exit pupil in the multi-layer diffractive waveguide.

One or more apparatus embodiments includes a computer system and a head-mounted display having a display waveguide. An apparatus comprises a computer system that provides an electronic signal representing image data. A head-mounted display provides image light in response to the electronic signal. The head-mounted display includes a waveguide display. The waveguide display includes a polarizing beam splitter to output image light. A microdisplay reflects the image light from the polarizing beam splitter back to the polarizing beam splitter that redirects the image light as redirected image light. A diffractive waveguide has an input diffraction grating to receive the redirected image light from the polarizing beam splitter. The redirected image light from the polarizing beam splitter passes through the input diffraction grating un-deviated. A quarter waveplate receives the redirected image light from the polarizing beam splitter and output the redirected image light. A curved reflector receives the redirected image light from the quarter waveplate. The curved reflector reflects and collimates the redirected image light back to the quarter waveplate that outputs the redirected image light to the input diffraction grating. The redirected image light from the quarter waveplate is diffracted by the input diffraction grating. The diffractive waveguide performs at least a function of another polarizing beam splitter. The diffractive waveguide outputs the image light to a projected exit pupil that is external to the diffractive waveguide.

In an apparatus embodiment, wherein the waveguide display includes a field of view and the diffractive waveguide includes the input diffraction grating to output a first portion of the field of view and another input diffraction grating to output a second portion of the field of view.

In another apparatus embodiment, the apparatus comprising a clean-up polarizer to receive the redirected image light from the polarizing beam splitter and output the redirected image light. A doublet receives the redirected image light from the clean-up polarizer and outputs the redirected image light to the diffractive waveguide.

In an apparatus embodiment, the diffractive waveguide includes a plurality of layers, wherein a first layer, in the plurality of layers, includes a first input diffraction grating formed by a first ray of light diffracted by a first hologram and a second ray of light that passes through the first hologram.

In an apparatus embodiment, the diffractive waveguide includes a second layer in the plurality of layers. The second layer includes a first input diffraction grating formed by a third ray of light diffracted by a second hologram and a fourth ray of light that passes through the second hologram. The first hologram is associated with a first light having a first set of wavelengths and the second hologram is associated with a second light having a second set of wavelengths.

Embodiment described in the previous paragraphs may also be combined with one or more of the specifically disclosed alternatives.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts that would be recognized by one skilled in the art are intended to be within the scope of the claims.

What is claimed is:

1. An apparatus comprising:
a polarizing beam splitter to output image light;
a microdisplay to reflect the image light from the polarizing beam splitter back to the polarizing beam splitter that redirects the image light as redirected image light;
a diffractive waveguide having an input diffraction grating to receive the redirected image light from the polarizing beam splitter, the redirected image light from the polarizing beam splitter passes un-deviated through the input diffraction grating;
a quarter waveplate to receive the redirected image light from the polarizing beam splitter and output the redirected image light; and
a curved reflector to receive the redirected image light from the quarter waveplate, the curved reflector reflects and collimates the redirected image light back to the quarter waveplate that outputs the redirected image light to the input diffraction grating, the redirected image light from the quarter waveplate is diffracted by the input diffraction grating.

2. The apparatus of claim 1, wherein the diffractive waveguide is included in a display that provides a field of view, wherein the diffractive waveguide includes the input diffraction grating that provides a portion of the field of view and another diffraction input grating that provides a second portion of the field of view.

3. The apparatus of claim 1, wherein the diffractive waveguide performs at least a function of another polarizing beam splitter.

4. The apparatus of claim 1, comprising:
a clean-up polarizer to receive the redirected image light from the polarizing beam splitter and output the redirected image light; and
a doublet to receive the redirected image light from the clean-up polarizer and output the redirected image light to the diffractive waveguide.

5. The apparatus of claim 1, wherein at least a portion of the polarizing beam splitter, microdisplay, curved reflector and quarter waveplate are coplanar.

6. The apparatus of claim 1, comprising a printed circuit board,
wherein the polarizing beam splitter, microdisplay, curved reflector and quarter waveplate are disposed on the printed circuit board.

7. The apparatus of claim 1, wherein the diffractive waveguide includes a plurality of layers, wherein the quarter waveplate outputs the redirected image light through the diffractive waveguide to a projected exit pupil.

8. The apparatus of claim 7, wherein a first layer, in the plurality of layers, includes the input diffraction grating having a first k-vector and a second layer in the plurality of layers includes another input diffraction grating having a second k-vector, the first k-vector is different than the second k-vector.

9. The apparatus of claim 7, wherein the apparatus is included in a near-eye display device having a projection light engine and near-eye display,
the projection light engine including the polarizing beam splitter, microdisplay, curved reflector and quarter waveplate, and
the near-eye display includes the diffractive waveguide.

10. A method comprising:
directing a first ray of light along a first optical path to a first hologram;
diffracting, by the first hologram, the first ray of light to a second optical path through a first copy substrate;
directing a second ray of light along a third optical path to the first hologram; and
allowing the second ray of light to pass through the first hologram along the third optical path, the second ray of light intersect the first ray of light at a first point in the first copy substrate that forms a first input diffraction grating of the first copy substrate.

11. The method of claim 10, comprising:
diffracting, by the first hologram, the second ray of light along a fourth optical path to the first copy substrate;
directing a third ray of light along a fifth optical path to the first hologram; and
allowing the third ray of light to pass through the first hologram along the fifth optical path, the third ray of light intersect the second ray of light at a second point in the first copy substrate that forms a second input diffraction grating of the first copy substrate,
wherein the first input diffraction grating has a first k-vector and a second k-vector,
wherein the first k-vector is different than the second k-vector.

12. The method of claim 10, comprising:
directing a fifth ray of light along a sixth optical path to a second hologram;
diffracting, by the second hologram, the fifth ray of light to a seventh optical path through a second copy substrate;
directing a sixth ray of light along a eighth optical path to the second hologram; and
allowing the sixth ray of light to pass through the second hologram along the eighth optical path, the sixth ray of light intersect the fifth ray of light at a first point in the second copy substrate that forms a first input diffraction grating of the second copy substrate.

13. The method of claim 12, wherein the first hologram is associated with a first light having a first set of wavelengths and the second hologram is associated with a second light having second set of wavelengths.

14. The method claim 13, comprising:
coupling the first copy substrate to the second copy substrate such that there is an air gap between the first copy substrate and the second copy substrate.

15. The method of claim 14, wherein the first copy substrate and second copy substrate form a first and second layer of a multi-layer diffractive waveguide used in a near-eye display that receives image light at an exit pupil in the multi-layer diffractive waveguide.

16. An apparatus comprising:
a computer system that provides an electronic signal representing image data; and
a head-mounted display that provides image light in response to the electronic signal, wherein the head-mounted display includes:
a waveguide display including:
a polarizing beam splitter to output image light;
a microdisplay to reflect the image light from the polarizing beam splitter back to the polarizing beam splitter that redirects the image light as redirected image light;
a diffractive waveguide having an input diffraction grating to receive the redirected image light from the polarizing beam splitter, the redirected image light from the polarizing beam splitter passes un-deviated through the input diffraction grating;
a quarter waveplate to receive the redirected image light from the polarizing beam splitter and output the redirected image light; and
a curved reflector to receive the redirected image light from the quarter waveplate, the curved reflector reflects and collimates the redirected image light back to the quarter waveplate that outputs the redirected image light to the input diffraction grating, the redirected image light from the quarter waveplate is diffracted by the input diffraction grating,
wherein the diffractive waveguide performs at least a function of another beam splitter and polarizing, the diffractive waveguide outputs the image light to a projected exit pupil that is external to the diffractive waveguide.

17. The apparatus of claim 16, wherein the waveguide display includes a field of view and the diffractive waveguide includes a first input diffraction grating to output a first portion of the field of view and a second input diffraction grating to output a second portion of the field of view.

18. The apparatus of claim 16, comprising:
a clean-up polarizer to receive the redirected image light from the polarizing beam splitter and output the redirected image light; and
a doublet to receive the redirected image light from the clean-up polarizer and output the redirected image light to the diffractive waveguide.

19. The apparatus of claim 16, wherein the diffractive waveguide includes a plurality of layers, wherein a first layer, in the plurality of layers, includes a first input diffraction grating formed by a first ray of light diffracted by a first hologram and a second ray of light that passes through the first hologram.

20. The apparatus of claim 19, wherein the diffractive waveguide includes a second layer in the plurality of layers, wherein the second layer includes a first input diffraction grating formed by a third ray of light diffracted by a second hologram and a fourth ray of light that passes through the second hologram, wherein the first hologram is associated with a first light having a first set of wavelengths and the second hologram is associated with a second light having a second set of wavelengths.
